(19) United States
(12) Patent Application Publication
(10) Pub. No.: US 2025/0255337 A1
(43) Pub. Date: Aug. 14, 2025

(54) MICROALGAE-ENRICHED FOODS

(71) Applicant: San Diego State University (SDSU) Foundation, dba San Diego State University Research Foundation, San Diego, CA (US)

(72) Inventors: Cristal ZUNIGA, San Diego, CA (US); Jing ZHAO, San Diego, CA (US); Changqi LIU, San Diego, CA (US)

(21) Appl. No.: 19/051,839

(22) Filed: Feb. 12, 2025

Related U.S. Application Data
(60) Provisional application No. 63/552,295, filed on Feb. 12, 2024.

(51) Int. Cl. A23L 33/135

(52) U.S. Cl. CPC A23L 33/135

(57) ABSTRACT

In alternative embodiments, provided are compositions, including products of manufacture, foods and drinks and kits, comprising one or mixtures of two or more or a plurality of microalgae, wherein the microalgae, optionally blue-green algae or cyanobacteria, or extracts of the microalgae, or dried extracts of the microalgae, are formulated into a food, candy, nutritional supplement, or an ingestible liquid. In alternative embodiments, the one or two or more or a plurality of microalgae comprise a microalgae from the genus: Spirulina sp., Arthrospira sp., Limnospira sp, Dunaliella salina, and/or Nannochloropsis salina. In alternative embodiments, the one or two or more or a plurality of microalgae are formulated into a food such as a guacamole (to generate for example, to generate a Microalgae-Enriched Guacamole (MEG).

### RELATED APPLICATIONS

This U.S. utility patent application claims the benefit of priority under 35 U.S.C. § 119(e) to U.S. Provisional Patent Application Ser. No. 63/552,295, Feb. 12, 2024. The aforementioned application is expressly incorporated herein by reference in its entirety and for all purposes.

### STATEMENT AS TO FEDERALLY SPONSORED RESEARCH

This invention was made with government support under DB12313313 awarded by the National Science Foundation, USDA-NIFA-AFRI 2024-67017-42676 awarded by the United States Department of Agriculture, NNH24ZHA003C awarded by the National Aeronautics and Space Administration, and DE-SC0025445 awarded by the United States Department of Energy. The government has certain rights in the invention.

### TECHNICAL FIELD

This invention generally relates to nutrition and probiotics. In alternative embodiments, provided are compositions, including products of manufacture, foods and drinks and kits, comprising one or mixtures of two or more or a plurality of microalgae, wherein the microalgae, optionally blue-green algae or cyanobacteria, or extracts of the microalgae, or dried extracts of the microalgae, are formulated into a food, candy, nutritional supplement, or an ingestible liquid. In alternative embodiments, the one or two or more or a plurality of microalgae comprise a microalgae from the genus: Spirulina sp., Chlorella sp., Dunaliella sp., and/or Nannochloropsis sp., or are Chlorella vulgaris, Dunaliella salina, and/or Nannochloropsis salina. In alternative embodiments, the one or two or more or a plurality of microalgae are formulated into a food such as a guacamole (to generate for example, to generate a Microalgae-Enriched Guacamole (MEG).

### BACKGROUND

The biomass of microalgae is the source of essential amino acids, vitamins, minerals, and antioxidants.

There are challenges for the food chain such as resupply, spoilage, appropriate nutrient content, and enough caloric value.

Remote environments, such as spaceflight, lack access to fresh foods. Pre-packaged foods are known not to be as healthy as fresh foods that we can get here on Earth.

There are challenges for the food chain during long-space travel such as resupply, spoilage, appropriate nutrient content, and enough caloric value. Instant nutritious freeze-dried foods deserts meet these criteria. Therefore, space food should be enriched with vitamins and antioxidants to combat oxidative stress and DNA damage due to radiation. Increasing essential amino acids, K, and polyphenols can help control muscle atrophy under microgravity. Similarly, increased omega-3 fats and Mg may minimize bone resorption and renal stone issues.

Avocados are rich in unsaturated fats (oleic and linoleic), fiber, minerals (K, P, Mg, Ca, Se), vitamins (C, E, B3, and B5), and phytochemicals (flavonoids), being part of healthy diets. The nutritional value of avocados can be enhanced with the addition of D. salina and N. salina, rich in essential amino acids (Phe, Leu, Thr, Val, and Ile), omega-3 fats (EPA and DHA), and antioxidants (9-cis β-carotene, zeaxanthin, astaxanthin, and lutein).

### SUMMARY

In alternative embodiments, provided are products of manufacture, foods, drinks, nutritional supplements, pills, tablets, capsules, gels, geltabs, dosage forms and kits comprising one or mixtures of two or more or a plurality of microalgae, or mixtures of two or more different types (or species) of microalgae,

wherein the one or two or more or a plurality of microalgae, or one of a mixture of two or more different types (or species) of microalgae, comprise a microalgae from the genus: Spirulina sp., Arthrospira sp., Limnospira sp., Chlorella sp., Dunaliella sp., and/or Nannochloropsis sp., or are Chlorella vulgaris, Dunaliella salina, and/or Nannochloropsis salina,

and optionally the one or mixtures of two or more or plurality of microalgae, or the mixtures of two or more different types (or species) of microalgae, comprise: blue-green algae or cyanobacteria, or extracts of the microalgae, or dried extracts of the microalgae, formulated into a food, candy, nutritional supplement, or an ingestible liquid.

In alternative embodiments, of the products of manufacture, foods, drinks, nutritional supplements, pills, tablets, capsules, gels, geltabs, dosage forms or kits as provided herein:
the products of manufacture, foods, drinks, nutritional supplements, pills, tablets, capsules, gels, geltabs, dosage forms or kits further comprises a prebiotic or a probiotic or a mixture thereof, and optionally the prebiotic is or are partially or substantially dehydrated or lyophilized;
the probiotic comprises a bacteria, an algae, or a blue-green algae or cyanobacteria or a mixture thereof;
the prebiotic comprises a water-soluble carbohydrate (wherein optionally the water-soluble carbohydrate comprises one or more of inulin, oligofructose, fructo-oligosaccharide, galacto-oligosaccharide, glucose, starch, maltose, maltodextrins, polydextrose, amylose, sucrose, fructose, lactose, isomaltulose, a polyol), glycerol, carbonate, thiamine, choline, histidine, trehalose, nitrogen, sodium nitrate, ammonium nitrate, phosphorus, phosphate salts, hydroxyapatite, potassium, potash, sulfur, homopolysaccharide, heteropolysaccharide, cellulose, chitin, a vitamin, a protein source (optionally whey protein, casein, casein protein, nonfat milk, hydrolyzed protein) or any combination thereof;
the two or more or plurality of microalgae, or the one of the mixture of two or more different types (or species) of microalgae, comprise:
a species of the genus Spirulina, and a species of the genus Chlorella;
a species of the genus Spirulina, and a species of the genus Dunaliella;
a species of the genus Dunaliella and a species of the genus Chlorella;
a species of the genus Arthrospira, a species of the genus Limnospira;
a species of the genus Spirulina, a species of the genus Limnospira;
a species of the genus Arthrospira, a species of the genus Spirulina;
a species of the genus Spirulina, Arthrospira, and Limnospira;
a species of the genus Dunaliella and a species of the genus Arthrospira;
a species of the genus Chlorella and a species of the genus Arthrospira;
a species of the genus Dunaliella and a species of the genus Limnospira; or
a species of the genus Chlorella and a species of the genus Limnospira;
the one or mixtures of two or more or a plurality of microalgae, or mixtures of two or more different types (or species) of microalgae, are mixed with or incorporated into a drink, dietary supplement, gel, food or vegetable, wherein optionally the one or mixtures of two or more or a plurality of microalgae, or mixtures of two or more different types (or species) of microalgae, are mixed with or incorporated into a food, drink, dietary supplement, gel or vegetable comprising avocado, and optionally the food is formulated as a Microalgae-Enriched Guacamole (MEG);
the one or mixtures of two or more or a plurality of microalgae, or the mixtures of two or more different types (or species) of microalgae, is or are partially or substantially dehydrated or lyophilized; and/or
the dosage form selected from the group consisting of: a suppository, a biocompatible scaffold, a powder, a liquid, a capsule, a chewable tablet, a swallowable tablet, a buccal tablet, a troche, a lozenge, a soft chew, a solution, a suspension, a spray, a powder, a tincture, a decoction, a infusion and any combination thereof.

In alternative embodiments provided are methods for supplementing the diet of an individual in need thereof comprising administering a product of manufacture, food, drink, nutritional supplement, pill, tablet, capsule, gel, geltab, dosage form or kit of claim 1, to the individual in need thereof, and optionally the individual in need thereof is an astronaut, an athlete, a soldier, an individual with a digestive or a growth disorder, a burn patient, a trauma victim, a post-surgical patient and/or a cancer patient or a patient with cachexia.

In alternative embodiments provides are uses of one or mixtures of two or more or a plurality of microalgae, or mixtures of two or more different types (or species) of microalgae, for supplementing the diet of an individual in need thereof, wherein the one or mixtures of two or more or plurality of microalgae, or mixtures of two or more different types (or species) of microalgae, comprises at least one microalgae from the genus: Spirulina sp., Chlorella sp., Dunaliella sp., and/or Nannochloropsis sp., or are Chlorella vulgaris, Dunaliella salina, and/or Nannochloropsis salina.

In alternative embodiments provided are mixtures of two or more or a plurality of microalgae, or a mixture of two or more different types (or species) of microalgae, for use in supplementing the diet of an individual in need thereof, wherein the one or mixtures of two or more or plurality of microalgae, or mixtures of two or more different types (or species) of microalgae, comprises at least one microalgae from the genus: Spirulina sp., Chlorella sp., Dunaliella sp., and/or Nannochloropsis sp., or are Chlorella vulgaris, Dunaliella salina, and/or Nannochloropsis salina.

The details of one or more exemplary embodiments of the invention are set forth in the accompanying drawings and the description below. Other features, objects, and advantages of the invention will be apparent from the description and drawings, and from the claims.

All publications, patents, patent applications cited herein are hereby expressly incorporated by reference in their entireties for all purposes.

### DESCRIPTION OF DRAWINGS

The drawings set forth herein are illustrative of exemplary embodiments provided herein and are not meant to limit the scope of the invention as encompassed by the claims.

FIG. 1 illustrates a table of data from experiments where a batch of samples was made based on differing types of algae, all at the same concentration of 2%, and each sample was evaluated for 12 attributes using a 9-point hedonic scale, highlighted are items that had that highest scores, as discussed in further detail in Example 1, below.

FIG. 2 graphically illustrates results of a study where Spirulina is the most favorable based on sensory evaluation; and a combination of Chlorella and Dunaliella were also well received; and after nutritional analyses we can determine which microalgae will strike a balance between nutrient density and palatability, as discussed in further detail in Example 1, below.

FIG. 3 schematically illustrates exemplary methodology for D. salina biomass composition determination.

FIG. 4A graphically illustrates: D. salina growth in Artificial Seawater Medium (1ASW): 0.6 M NaCl, 0.2 mM NO3, 24 H Light, 50 PPFD, pH: 8.0, 25° C.; and

FIG. 4B graphically illustrates: D. salina growth in 3ASW: 1.8 M NaCl, 5 mM NO3, 16 H Light, pH: 8.0, 25° C., varying photosynthetic photon flux densities.

FIG. 5 graphically illustrates optimization of D. salina cellular growth in 2.5ASW: 2.5 mM NO3, 16 H Light, pH: 8.0, 25° C., at different salinities, using cargon sources (upper graph) and nitrogen sources (lower graph); growth parameters adjusted to the Gompertz-Zwietering kinetic model.

FIG. 6 schematically illustrates the changes in the biochemical composition of D. salina over time at optimal laboratory growth conditions. Carotenoid and lipid content compatible with guacamole mix. Increased glycerol content impacts flavor.

FIG. 7A graphically illustrates D. salina growth in Artificial Seawater Medium (1ASW): 0.6 M NaCl, 0.2 mM NO3, 24 H Light, 50 PPFD, pH: 8.0, 25° C.; and

FIG. 7B graphically illustrates D. salina growth in 3ASW: 1.8 M NaCl, 5 mM NO3, 16 H Light, pH: 8.0, 25° C., varying photosynthetic photon flux densities.

FIG. 8 graphically illustrates optimization of D. salina cellular growth in 2.5ASW: 2.5 mM NO3, 16 H Light, pH: 8.0, 25° C., at different salinities. Growth parameters adjusted to the Gompertz-Zwietering kinetic model.

FIG. 9 graphically illustrates changes in the biochemical composition of D. salina over time at optimal laboratory growth conditions. Carotenoid and lipid content compatible with guacamole mix. Increased glycerol content impacts flavor.

FIG. 10 illustrates Table 1, a Flavor analysis, select key aroma-active compounds are identified in microalgae, as discussed in detail in Example 3, below.

Like reference symbols in the various drawings indicate like elements.

### DETAILED DESCRIPTION

In alternative embodiments, provided are compositions, including products of manufacture, foods and drinks and kits, comprising one or mixtures of two or more or a plurality of microalgae, wherein the microalgae, optionally blue-green algae or cyanobacteria, or extracts of the microalgae, or dried extracts of the microalgae, are formulated into a food, candy, nutritional supplement, or an ingestible liquid. In alternative embodiments, the one or two or more or a plurality of microalgae comprise a microalgae from the genus: Spirulina sp., Chlorella sp., Dunaliella sp., and/or Nannochloropsis sp., or are Chlorella vulgaris, Dunaliella salina, and/or Nannochloropsis salina. In alternative embodiments, the one or two or more or a plurality of microalgae are formulated into a food such as a guacamole (to generate for example, to generate a Microalgae-Enriched Guacamole (MEG).

There are challenges for the food chain such as resupply, spoilage, appropriate nutrient content, and enough caloric value, and the instant and nutritious freeze-dried foods, liquids, nutritional supplement and deserts are designed to meet these criteria and address this need.

Inventors have developed a Microalgae-Enriched Guacamole (MEG), an instant guacamole enriched with single and mixes of edible microalgae, including for example Spirulina sp., Chlorella vulgaris, Dunaliella salina, and Nannochloropsis salina. Flavor analysis was performed for all algae and new flavor compositions were designed. MEG was formulated with extracts of dry microalgae and avocado, ensuring stability, palatability, variety, usability, and nutrient density after hydration. Because biomass of the microalgae is the source of essential amino acids, vitamins, minerals, and antioxidants, this will expand the shelf life of a food (optionally avocado or guacamole), candy, nutritional supplement, or an ingestible liquid as provided herein. Targeted biomass composition of algae through metabolic modeling enabled control of the flavor and shelf properties of the avocado or guacamole.

Inventors have developed a shelf-stable avocado or guacamole enriched with a novel mixture of microalgae. In alternative embodiments, the avocado or guacamole are formulated as a dry mix, and can be consumed following rehydration with for example, water.

In alternative embodiments, inventors have designed a food, candy, nutritional supplement, or an ingestible liquid designed to provide or deliver essential nutrients and desirable flavors, ensuring both physical well-being and emotional satisfaction for the consumer, which can be an individual under stress or exposed to challenging conditions or challenging or remote environments, such as astronauts, athletes, soldiers, individuals with digestive or growth disorders, burn patients, trauma victims, post-surgical patients, and/or cancer patients.

### Formulations

In alternative embodiments, one or mixtures of two or more or a plurality of microalgae, such as blue-green algae or cyanobacteria, or extracts of the microalgae, or dried extracts of the microalgae, are formulated dried powders. For example, in alternative embodiments, the one or mixtures of two or more or a plurality of microalgae are formulated as a gel powder comprising: a polymer and a pectin, and then this mixture is exposed to a denaturation temperature (Td) of between about 318 K to about 378, or between about 159° C. to about 192° C.

In alternative embodiments, gelatin is added to the one or mixtures of two or more or a plurality of microalgae, or the gel powder, and optionally the gelatin is added at a Td of between about 330 to 480 K, or between about 57° C. to 207° C.

In alternative embodiments, gelation conditions comprise: pre-heating at about 210° C., then the microalgae and flavorings, if present, are added, the water or other liquid is added, for example, cold water is added. In alternative embodiments, the percent of microalgae added in this mix is between about 5% to 90% by weight, or by volume. The amount of microalgae added any particular mix as provided herein depends on desired taste, odor, texture and the like.

In alternative embodiments, foods, candies, nutritional supplements and ingestible liquids as provided herein address optimal space travel food composition requirements, which are to have the food, supplement or drink comprise between about 50 to 55% carbohydrates, between about 30 to 35% fat, and between about 12 to 15% protein. This composition can be precisely attained with edible microalgae using a model-driven culturing technology. The biomass of microalgae is the source of essential amino acids, vitamins, minerals, and antioxidants. NASA already considers the cyanobacteria Spirulina (Limnospira spp.) and microalgae (e.g., Chlorella spp. and Euglena gracilis) in their menu.

In alternative embodiments, provided is a Microalgae-Enriched Guacamole (MEG), an instant guacamole enriched with the edible microalgae Dunaliella salina and Nannochloropsis salina. In alternative embodiments, MEG as provided herein is formulated with extracts of microalgae and avocado, ensuring stability, palatability, variety, usability, and nutrient density.

Autotrophic and mixotrophic cultivation conditions for blue-green algae or cyanobacteria such as D. salina and N. salina can be optimized using a model-driven culturing technology in monocultures. A metabolic control algorithm can be used to control for a desired biomass composition. Microalgae is grown under these conditions, then harvested, deodorized and lyophilized following standard AOAC (Association of Official Analytical Chemists) protocols.

In alternative embodiments, ripe avocados are blanched, freeze-dried, and powderized following AOAC protocols.

In alternative embodiments, microalgae and avocado extracts are mixed and stabilized using standard protocols, with microalgae percentages of 2, 4, 6, or 12% w/w of the total mixture, or between about 1% and 50% w/w of the total mixture. In alternative embodiments these formulations or mixtures are mixed or added with other freeze-dried ingredients such as for example chopped onion, seasonings, citric acid and/or salt.

In alternative embodiments, fatty acids, amino acids, carotenoids, and antioxidant are added to a food, candy, nutritional supplement, or an ingestible liquid as provided herein, including being added to a microalgae and avocado extract mix.

In alternative embodiments, MEG samples are subjected to flavor analysis through a headspace solid phase microextraction, and can be analyzed using a GC-olfactometry-MS and the NIST Library. Aroma extract dilution analysis can identify the key aroma-active compounds in MEG. To identify the taste-active compounds in MEG, the amino acid content, peptide sequences, reducing sugars, and nucleotide contents are analyzed LC-MS.

In alternative embodiments different microalgae biomass compositions are used to address potential loss of nutritional composition of MEG during processing, a poor texture, potential off flavors, limited palatability, and discoloration of the final product.

In alternative embodiments, a food, candy, nutritional supplement, or an ingestible liquid as provided herein address and meet NASA nutrition goals, particularly as NASA aims to establish a long-term presence on the Moon, while pivoting exploration of Mars. A food, candy, nutritional supplement, or an ingestible liquid as provided herein address and meet challenges for long space travel by providing nourishing food that also tempts astronauts to eat. Therefore, a food, candy, nutritional supplement, or an ingestible liquid as provided herein can be a futuristic and instant source of nourishment, for example, in the form of a guacamole mix with edible microalgae; this can be healthy, nutritious, easy to prepare, and fun to eat. This exemplary product will also offer the possibility to be a source of amino acids, carbohydrates, lipids, vitamins, minerals, and antioxidants for culturing using light and CO₂ as only carbon sources.

In alternative embodiments microalgae are grow under high salinity preventing overgrowth of other organisms and ensuring long-term shelf times.

Throughout its cultivation cycle, D. salina changes its appearance, displaying green, yellow, and orange coloration as a result of the dynamic accumulation of pigments. Cultivation cycle can be optimized using growth kinetics parameters and to biochemical composition analysis of D. salina throughout its optimized growth cycle, focusing on total protein (Lowry method), carbohydrate (acid digestion method), lipid (gravimetric analysis), and photosynthetic pigment (cold acetone extraction) content.

The Gompertz-Zwietering growth kinetics model was used to estimate the autotrophic and mixotrophic growth parameters (i.e., biomass carrying capacity (A), growth rate, μmax, and lag time, λ) of D. salina during its reproduction at three different salinity levels (6% w/w, 8% w/w, and 9.5% w/w), and in the presence of citric acid at different initial concentrations (0, 1, 2.5, 5.0, 7.5, and 10 mM). It was determined that concentrations of ˜8% salinity and concentrations of approximately 5 mM of citric acid are factors that lead to increased growth rates in D. salina. Within the citric acid experiment, it was observed that cultures with citric acid had lower overall biomass production than cultures without it. After selecting the optimal salinity and citric acid levels, accurate biochemical composition data were measured over time to generate objective biomass equations that enhance the predictive capabilities of high-quality Genome-Scale Metabolic Reconstruction models. Moreover, the Gompertz-Zwietering kinetic parameters were used to establish cultivation times of the three different phenotypes that show up during the early exponential (green), late exponential (yellow), and stationary (orange) phases. The combination of kinetic analysis, proximate biochemical analysis, and biomass objective function results help determine optimal D. salina cultivation times to enhance the nutritional value of D. salina biomass incorporated in a space food product that is visually appealing.

In alternative embodiments, the unicellular, freshwater microalga Chlorella vulgaris is used for enhancing the nutritional value of functional and sustainable foods, liquids and nutritional supplements as provided herein due to its high-biomass productivity under various conditions. Recognized for its abundant protein content (>50% w/w), content of both essential and nonessential amino acids, as well as its abundant content of vitamins, minerals, and antioxidants (i.e., carotenoids, polyphenols, and flavonoids), C. vulgaris is gaining importance as a healthy and sustainable ingredient for space food within NASA's Artemis project. Resilient against harsh conditions in extreme environments and containing immune-modulating and anti-cancer properties, C. vulgaris biomass can improve the nutritional value and the prophylactic properties of freeze-dried foods.

Quantification or proximate biochemical composition analysis of C. vulgaris is done throughout its growth cycle, focusing on total protein (Lowry method), carbohydrate (acid digestion method), lipid (gravimetric analysis), and photosynthetic pigment (cold acetone extraction) content. Biochemical composition data is complemented with the determination of Gompertz-Zwietering growth kinetics parameters (i.e., biomass carrying capacity (A), growth rate, μmax, and lag time, λ) to better understand the dynamic biochemistry of C. vulgaris during its reproduction.

In alternative embodiments, accurate biochemical composition data is used for curation of objective biomass equations that enhance the predictive capabilities of high-quality Genome-Scale Metabolic Reconstruction models. Overall trends indicate that protein content decreases over time as C. vulgaris cells progress further along in their growth cycle while increasing carbohydrate accumulation over time. Interestingly, the lipid and photosynthetic pigment fractions remained constant at the optimized autotrophic growth conditions in Bold's Basal medium. This quantitative analysis can provide a basis to select the optimal culture age for harvesting the microalgal biomass, for example, for developing a food, for example, an astronaut food or drink.

Microalgae are a rich source of nutrients and bioactive compounds, which are vital for space travel. In alternative embodiments, Dunaliella salina, an edible marine alga rich in carotenoid pigments (e.g., β-carotene and 9-cis-β-carotene), that has great potential as a sustainable food ingredient is used in making products as provided herein. Additionally, it provides therapeutic effects against atherosclerosis, fatty liver, diabetes, retinitis pigmentosa, psoriasis, and radiation-induced cellular lipid degradation [1,2].

### Products of Manufacture and Kits

Provided are products of manufacture and kits for practicing methods as provided herein; and optionally, products of manufacture and kits can further comprise instructions for practicing methods as provided herein.

Any of the above aspects and embodiments can be combined with any other aspect or embodiment as disclosed here in the Summary, Figures and/or Detailed Description sections.

As used in this specification and the claims, the singular forms “a,” “an” and “the” include plural referents unless the context clearly dictates otherwise.

Unless specifically stated or obvious from context, as used herein, the term “or” is understood to be inclusive and covers both “or” and “and”.

Unless specifically stated or obvious from context, as used herein, the term “about” is understood as within a range of normal tolerance in the art, for example within 2 standard deviations of the mean. About (use of the term “about”) can be understood as within 20%, 19%, 18%, 17%, 16%, 15%, 14%, 13%, 12% 11%, 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless specifically stated or obvious from context, as used herein, the terms “substantially all”, “substantially most of”, “substantially all of” or “majority of” encompass at least about 75%, 80%, 85%, 90%, 91%, 92%, 93%, 94%, 95%, 96%, 97%, 98%, 99% or 99.5%, or more of a referenced amount of a composition.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents. Incorporation by reference of these documents, standing alone, should not be construed as an assertion or admission that any portion of the contents of any document is considered to be essential material for satisfying any national or regional statutory disclosure requirement for patent applications. Notwithstanding, the right is reserved for relying upon any of such documents, where appropriate, for providing material deemed essential to the claimed subject matter by an examining authority or court.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, and yet these modifications and improvements are within the scope and spirit of the invention. The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. Thus, the terms and expressions which have been employed are used as terms of description and not of limitation, equivalents of the features shown and described, or portions thereof, are not excluded, and it is recognized that various modifications are possible within the scope of the invention. Embodiments of the invention are set forth in the following claims.

The invention will be further described with reference to the examples described herein; however, it is to be understood that the invention is not limited to such examples.

### EXAMPLES

### Example 1

This example describes development of microalgae-comprising edible products as provided herein.

To explore the flavor profile of microalgae, volatile compositions of dried Arthrospira platensis, Chlorella vulgaris, and Dunaliella salina biomass were analyzed using headspace solid-phase microextraction and gas chromatography-olfactometry-mass spectrometry (HS-SPME/GC-O-MS).

A prototype of freeze-dried guacamole mix was created and the effects of processing order (freeze-drying before or after formulating the product), product fineness (pureed versus mashed), water content for rehydration, and lime juice quantity on color, texture, and flavor of the product were examined. Pureed products were found to exhibit reduced bitterness and a spreadable texture. Rehydration with 80% of the removed water yielded the most favorable texture.

Inventors have developed model-driven approaches to optimize biomass composition as a function of culturing conditions for microalgae such as Chlorella vulgaris [8-9]. Similar modeling frameworks can be used for D. salina and N. salina, both with a nutritional value that can broaden the usability of microalgae, which are already part of baked foods, beverages, dairy, snacks, and pasta [10].

The inventors developed a shelf-stable guacamole dry mix enriched with microalgae, which can be enjoyed following rehydration. The product is designed to deliver essential nutrients and desirable flavors, ensuring both physical well-being and emotional satisfaction for the consumer, for example for an astronaut. Combining avocado with microalgae, formulations as provided herein strike a balance between stability, palatability, convenience, and nutrient density.

To explore the flavor profile of microalgae, volatile compositions of dried Arthrospira platensis, Chlorella vulgaris, and Dunaliella salina biomass were analyzed using headspace solid-phase microextraction and gas chromatography-olfactometry-mass spectrometry (HS-SPME/GC-O-MS). Over 60 volatile compounds were detected using an HP-5 capillary column.

Different microalgae species exhibited distinct odor profiles. For example, A. platensis exhibited a pronounced licorice-like odor attributed to its high concentration of anethole, whereas D. salina offered a more delicate fragrance characterized by floral and seaweed-like notes, primarily due to the presence of α-ionone and trans-β-ionone. Undesirable odorants of microalgae can be characterized and removed in the product development process.

Inventors created an exemplary freeze-dried guacamole mix and examined the effects of processing order (freeze-drying before or after formulating the product), product fineness (pureed versus mashed), water content for rehydration, and lime juice quantity on color, texture, and flavor of the product. Preparing guacamole before freeze-drying ensured consistent drying and texture. Also, it prevented enzymatic browning in the dried products due to the inclusion of acids from lime juice.

Pureed products exhibited reduced bitterness and a spreadable texture, while mashed products were more bitter but had a texture closer to traditional guacamole. Rehydration with 80% of the removed water yielded the most favorable texture.

Microalgae used in products as provided herein are a rich source of nutrients and bioactive compounds, which are vital for space travel; for example, Dunaliella salina, an edible marine alga, are rich in carotenoid pigments (e.g., β-carotene and 9-cis-β-carotene), and have great potential as a sustainable food ingredient. Additionally, it provides therapeutic effects against atherosclerosis, fatty liver, diabetes, retinitis pigmentosa, psoriasis, and radiation-induced cellular lipid degradation [1,2].

Inventors employed a metabolic network analyses for the development of microalgal farms in extraterrestrial environments such as the Moon, Mars, or even Titan. Deploying high-throughput phenotyping tools, inventors we identified key substrates that enhance carotene accumulation in D. salina, constituting up to 12% of dry cell biomass. The carbon and nitrogen sources in the growth medium drive the nutritional composition of microalgae [3]. From a pool of 190 carbon and 95 nitrogen sources tested experimentally, inventors identified five of each that significantly affect carotenes and cellular growth of D. salina. Combinations of these substrates at different concentrations led to the expression of three distinct colored phenotypes: cells with low (green), medium (yellow), and high (orange) carotenoid concentrations. These three distinct colored phenotypes were subject to biomass composition measurements, including carbohydrate content, lipid profile, amino acid composition, nucleotides, and detailed pigment content. Targeted metabolomics profiling indicated that cellular growth with different substrates affects not only pigmentation but also the cysteine and methionine contents. These amino acids are associated with the taste and olfactory properties of foods with sulfurous flavors, such as avocados [4]. This data informs the metabolic network analysis.

In alternative embodiments, a genome-scale metabolic model (GSMM) is used. Biomass composition data from the three distinct phenotypes is used to define biomass objective functions for the GSMM and simulate growth conditions with different nutrients. The accuracy of the model can be assessed by calculating true positive, true negative, false positive, and false negative ratios using the experimental phenotyping data. By combining the GSMM with phenotyping tools, optimal growth conditions to obtain a flavorful microalgal biomass with enhanced antioxidant properties that can be used for innovative astronaut food can be defined, for example, an instant guacamole that can be consumed following rehydration or as is can be defined.

Dunaliella salina is an edible unicellular microalgae known for its antioxidant content, for example, β-Carotene and 9-cis-β-Carotene); and D. salina biomass is rich in edible proteins (great than 40%), lipids (great than 15%), vitamins, and minerals becoming an excellent source of nutrients for the consumer, for example, an astronaut, and meets criteria for food that being designed within NASA's Artemis project.

For product developments, several prototypes were developed to help determine:
Processing order (freeze-drying before or after formulating the product),
Texture (pureed versus mashed),
Water content for rehydration,
Acid type and quantity,
Microalgae type and amount.

Sensory parameters were: descriptors: Green tea, grassy, seaweed, fishy, salty, raw/cooked shrimp; Taste: Salty, sour, sweet and bitter; Pure Standard Compounds for Aroma: Nutty, paint, lemon, sulfur, rancid, almonds cilantro.

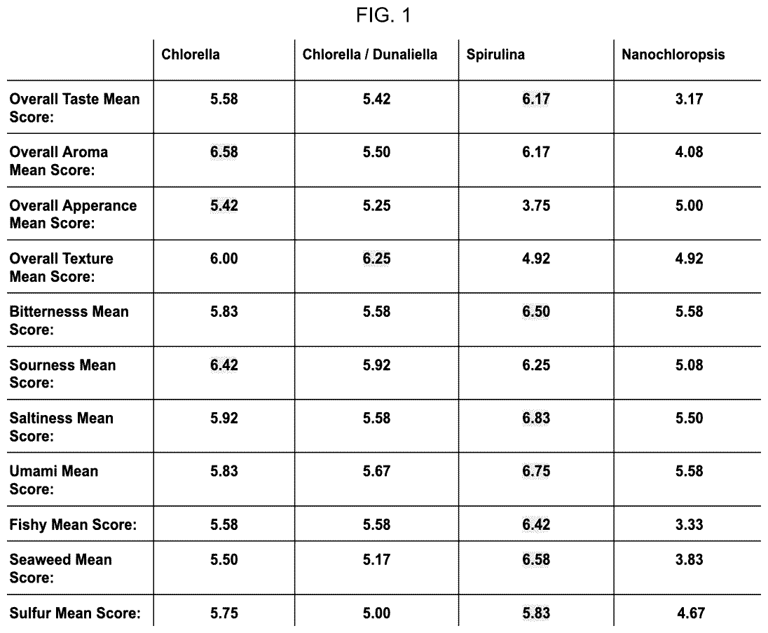

The last batch of samples were made based on differing types of algae, all at the same concentration of 2%. Each sample was evaluated for 12 attributes using a 9-point hedonic scale, and data illustrated in FIG. 1, where highlighted are items that had that highest scores. Based on these attributes, Spirulina exhibits the most favorable results. Between the attributes, texture and appearance show the biggest areas of opportunity.

### Overall Liking

Chlorella: 59%
Chlorella/Dunaliella: 75%
Spirulina: 75%
Nannochloropsis: 16%

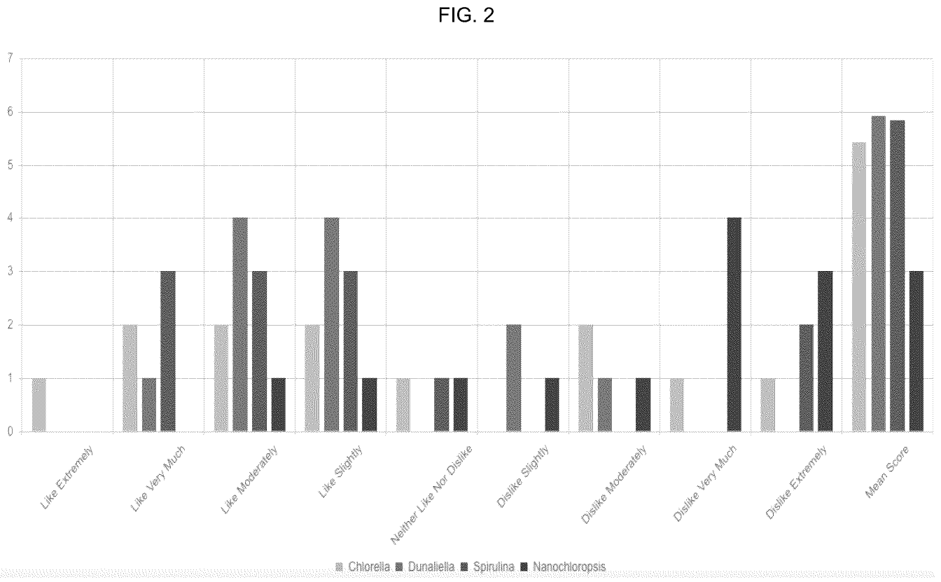

Given our results, as illustrated in FIG. 2, Spirulina is the most favorable based on sensory evaluation; however, a combination of Chlorella and Dunaliella were also well received. After nutritional analyses we can determine which microalgae will strike a balance between nutrient density and palatability. Shelf-life extension between all the samples can ensure stability over long periods of time.

Biomass Composition Determination of D. salina:

Total protein, total lipid, total carbohydrate, glycerol content, and total pigment content of microalgal biomass are determined spectrophotometrically and gravimetrically. The genome sequence of strain Dunaliella salina CCAP 19/18 [3] is used to develop the GSM [4].

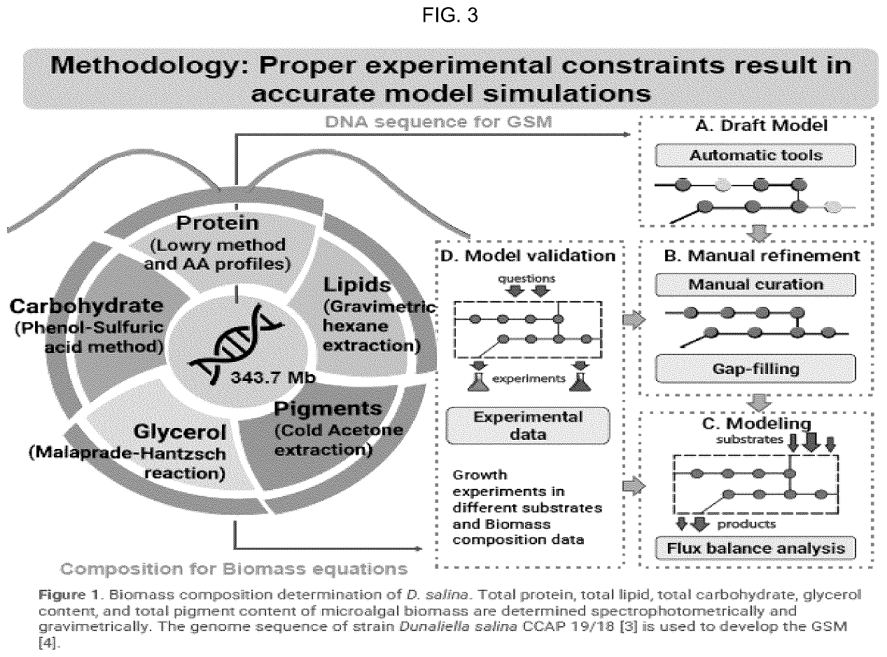

FIG. 3 schematically illustrates exemplary methodology for D. salina biomass composition determination.

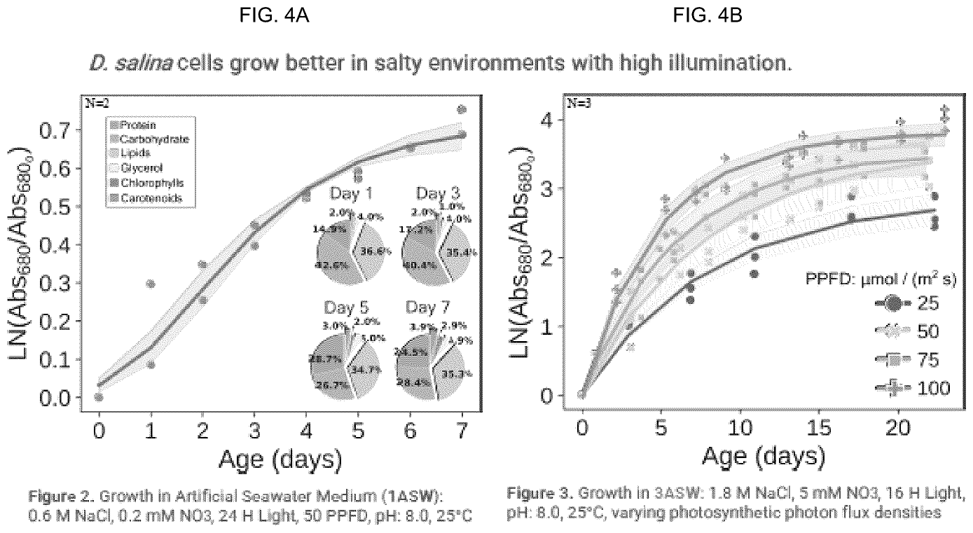

FIG. 4A illustrates: D. salina growth in Artificial Seawater Medium (1ASW): 0.6 M NaCl, 0.2 mM NO3, 24 H Light, 50 PPFD, pH: 8.0, 25° C.

FIG. 4A illustrates: D. salina growth in 3ASW: 1.8 M NaCl, 5 mM NO3, 16 H Light, pH: 8.0, 25° C., varying photosynthetic photon flux densities.

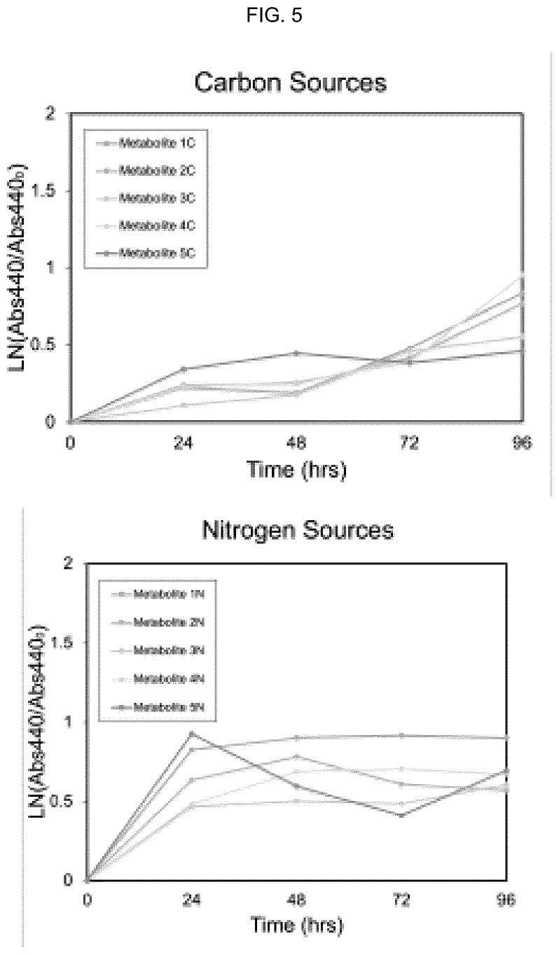

FIG. 5 illustrates optimization of D. salina cellular growth in 2.5ASW: 2.5 mM NO3, 16 H Light, pH: 8.0, 25° C., at different salinities. Growth parameters adjusted to the Gompertz-Zwietering kinetic model.

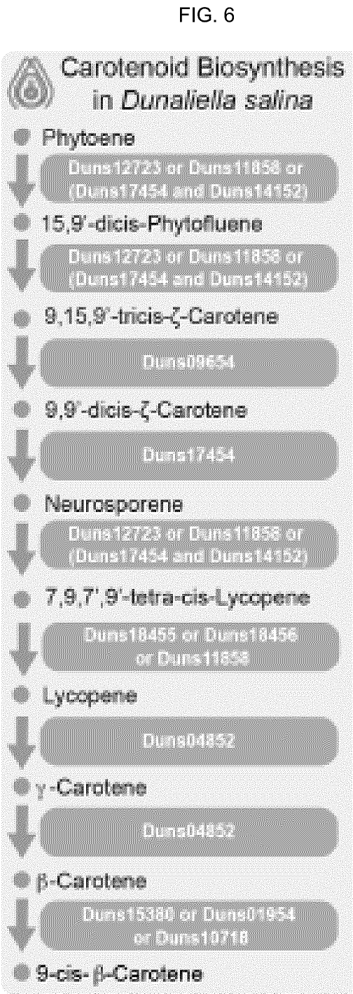

FIG. 6 illustrates changes in the biochemical composition of D. salina over time at optimal laboratory growth conditions. Carotenoid and lipid content compatible with guacamole mix. Increased glycerol content impacts flavor.

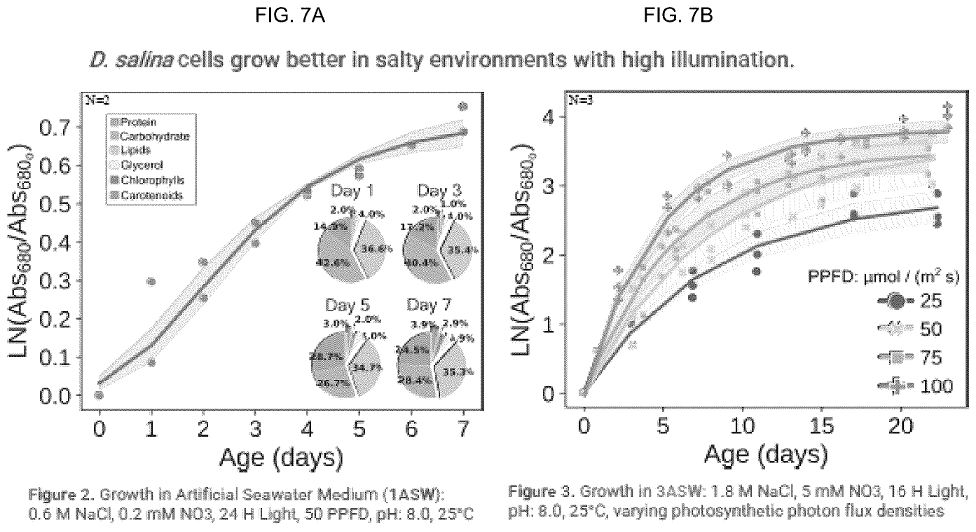

FIG. 7A illustrates D. salina growth in Artificial Seawater Medium (1ASW): 0.6 M NaCl, 0.2 mM NO3, 24 H Light, 50 PPFD, pH: 8.0, 25° C.

FIG. 7B illustrates D. salina growth in 3ASW: 1.8 M NaCl, 5 mM NO3, 16 H Light, pH: 8.0, 25° C., varying photosynthetic photon flux densities.

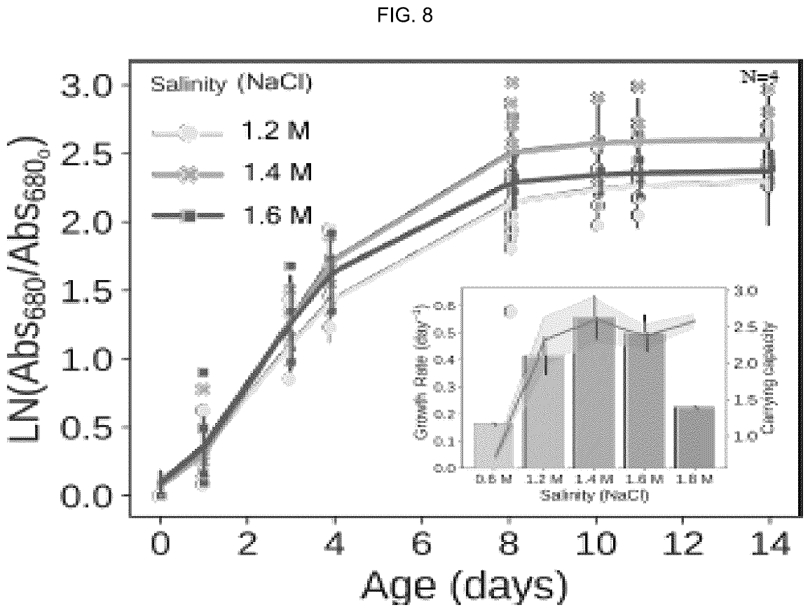

FIG. 8 illustrates optimization of D. salina cellular growth in 2.5ASW: 2.5 mM NO3, 16 H Light, pH: 8.0, 25° C., at different salinities. Growth parameters adjusted to the Gompertz-Zwietering kinetic model.

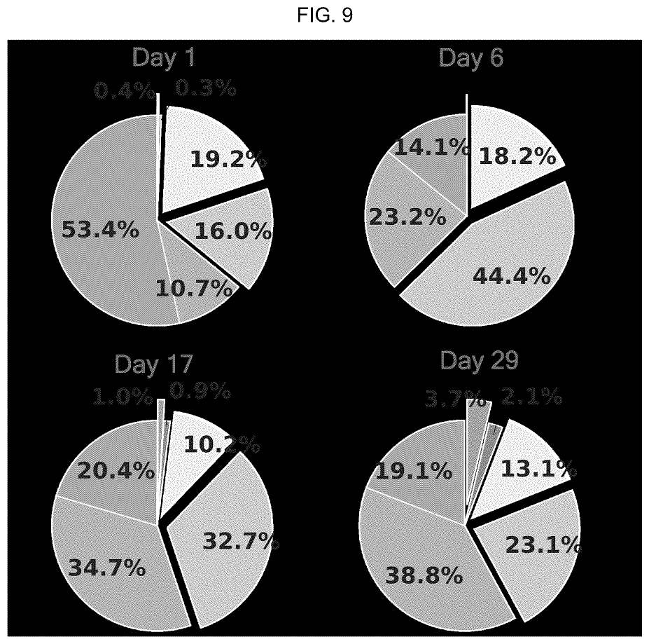

FIG. 9 illustrates changes in the biochemical composition of D. salina over time at optimal laboratory growth conditions. Carotenoid and lipid content compatible with guacamole mix. Increased glycerol content impacts flavor.

### Example 2: Exemplary Formulations and Recipes for Making Foods as Provided Herein

Microalgae recipes: to which the one or mixtures of two or more or a plurality of microalgae, or mixtures of two or more different types (or species) of microalgae as provided herein, or products of manufacture, foods, drinks, nutritional supplements, pills, tablets, capsules, gels, geltabs, dosage forms are added:
Materials: Mixing bowl, Silicone spatula, Entree or serving fork, Pasta extruder, Nitrile Gloves.

Spirulina Fresh Pasta

| | | |
|---|---|---|
| 2 | cups | AP Flour |
| 3 | T | spirulina |
| 3 | each | eggs |
| ⅓ | cup | evoo |
| ½ | tsp | sea salt |

| | |
|---|---|
| As needed | filtered water |

In mixing bowl, mix flour, algae and salt.
Make a well in the center and add in eggs and oil.
Incorporate all ingredients with a fork
   If to dry add water 1 tsp at a time
Turn out onto a floured board and need 5 minutes
run through pasta extruder
   Store in a sealed container, refrigerated for up to 5 days.

### Hummus

Two each 15 ounce cans, garbanzo beans, drained (reserve liquid)
½ cup Evoo
1 T fresh Garlic
1 tsp Salt
¼ tsp Pepper
¼ cup Tahini
2 Lemons, juice only
½ cup Aqua faba
⅛ tsp hot paprika

Drain garbanzo beans, but reserve liquid. Add garbanzo's and remaining ingredients with the exception of olive oil to food processor and blend until smooth. Slowly add olive oil oil store in an airtight container.

### Spirulina Addition

2 cups control hummus
1 T Spirulina
½ tsp sesame oil, tstd
⅛ tsp ginger powder (fresh)
¼ tsp chili oil

### Chlorella Addition

2 cups control hummus
1 T Chlorella
⅓ cup fresh basil leaves
¼ cup walnuts
1 tsp fresh garlic
1 lemon
¼ tsp salt

### 50/50 Addition

2 cups control hummus
1½ tsp each Chlorella and Spirulina
2 T Tajin
1 tsp smoked sweet paprika
3 T cotija cheese (use ¼ cup)
“everything but the corn elote”

### Chili Crisp

2 oz dry chili flake
¼ cup tstd sesame
1¼ cup corn oil
½ cup fried onion
¼ cup fried garlic

In a dry heavy bottom pan toast chili flakes on low heat until color changes one shade. Add toasted sesame and stir in remaining ingredients. Remove from heat, cool and store in an airtight jar.

### Spirulina Addition

4 oz control chili crisp
1 tsp Spirulina

### Chlorella Addition

4 oz control chili crisp
1 tsp Chlorella
50/50 addition
4 oz control chili crisp
½ tsp Chlorella
½ tsp Spirulina

### Furikake Almonds

1 #raw almonds
Wet:
1 egg white
1 tsp h2o
1 tsp soy sauce
Dry: mix and set aside
1 Tbls sugar
1 tsp white sesame
1 tsp black sesame
2 Tbls Minced Nori
1 tsp Spirulina
1 tsp Chlorella
¼ tsp Nanami Togarashi

### Preheat to 250 F

Whip egg whites with water and soy to soft meringue
   Tossed almonds to coat in meringue
   Add seasoning mix
   Bake on parchment lined paper, stirring every 20 minutes for one hour and 20 minutes
   Cool, completely in store an air tight container.
   Matcha Ginger Tea with Spirulina

Ginger-Turmeric Syrup

| | | |
|---|---|---|
| 2 | oz | fresh ginger, sliced |
| 2 | oz | fresh turmeric, sliced |
| 1 | cup | sugar |
| 1 | cup | water |

place all ingredients in a non reactive pot
Bring to a boil then remove from heat and cool before straining
2 cups Calahula Coconut cream

| | |
|---|---|
| 2 T | Matcha powder |
| 1 T | Spirulina |

blend all ingredients and store in the refrigerator
   To assemble drink

### Add 2 Tablespoons (1 fl oz) Ginger Syrup and

1 Tablespoon Matcha blend to a heat proof cup and stir in 1 cup boiling water.

### Example 3: Metabolic Network Analysis Reveals the Hidden Bioproduction Potential of Halophilic Microalga Dunaliella salina: Characterizing Dynamic Flavor Profiles in the Marine Algae Dunaliella salina Using Genome-Scale Metabolic Model

Systems biology approaches have enabled genome-scale computational metabolic models to accurately represent the metabolism of microorganisms. In photosynthetic microorganisms, models can leverage metabolic robustness and diversity for biotechnological processes. A key focus in sustainable pigment production using microalgae is that Dunaliella salina can produce up to 19% wt/wt carotenoids. Additionally, the biomass of D. salina contains antioxidants and amino acids for food and therapeutic applications. However, little is known of their flavor profiles at genome-scale for further consumer acceptance.

The metabolic model of D. salina was reconstructed to study the dynamics in the metabolism and in pigment production as well as flavor profiles. Extensive manual curation resulted in a model with 3,301 reactions (969 new in BIGG), 2,481 metabolites (new 672) and 941 genes, allowing the metabolic network to predict phenotypes under various growth conditions. Computationally and experimentally, three color phenotypes were identified over the course of growth (green, yellow and orange) while obtaining biomass compositional data of amino acids, carbohydrates, lipids, and pigments using chromatography. This information was used as a constraint to simulate dynamic flux distributions. Then, changes in fluxes were compared with flavor metabolites identified using GC-MS Olfactometry using biomass collected in 100 L raceway ponds. Ultimately, using the model we identified changes in 37 bitter compounds. The metabolic network of D. salina provides new insights into the flavor metabolism of marine algae as well as informs cultivation strategies for specific flavor contents.

A grand challenge facing humanity is supporting the growing human population in a sustainable manner. Meeting this challenge will require the identification and development of new and innovative renewable production systems. An innovative approach is to biologically capture carbon dioxide (CO₂) and convert this greenhouse gas into useful commodity products such as pigments. Algae are excellent producers of pigments and represent an exciting potential to sustainability because they generate pigments through their ability to convert CO₂ and light. Microalgae species grown in fresh and marine algae are particularly appealing because they have the capacity to generate specialty carotenoid pigments using natural pathways that can serve important medical roles for disease prevention. Several species of pigment production microalgae have been identified such as Dunaliella salina and Haematococcus lacustris, which display growth under autotrophic and/or heterotrophic conditions with limited possibilities of contamination in large-scale, representing an outstanding production system for production of valuable carotenoids.

Saltwater ecosystems are essential for biodiversity conservation. Hypersaline lakes (i.e., with salt concentrations over 35 g/L), require further attention because they harbor microorganisms that have evolved to withstand extreme environmental conditions. Adaptation to extreme environments is crucial in a world experiencing climate change, ocean disruption, and even racing to take humans to space permanently. Microalgae (namely unicellular eukaryote algae and cyanobacteria) represent emerging bioproduction systems with numerous applications in green specialty chemistry, environmental bioremediation, and alternative food systems. Among these, the halophilic chlorophyte Dunaliella salina has drawn interest as a versatile microalgal biofactory with high nutritional value, ocular disease prevention properties, neuroprotective capacity, and toxic element biosorption potential.

The strain Dunaliella salina CCAP 19/18 has become a representative member of the D. salina species, allowing progress on extremophilic microalgae biotechnology. The whole genome sequence of D. salina CCAP 19/18 was initially published in 2017 and metabolic reconstructions of its central carbon metabolism were presented in 2020. They have a natural capacity to accumulate weight as β-Carotene, 9-cis-β-Carotene, and other pigments.

Unfortunately, the cell densities obtained with D. salina and H. lacustris and other microalgal species using sunlight and CO₂ are often much lower compared to heterotrophic processes using multi carbon substrates. As a result, unraveling smart cultivation processes for the production pigments that utilize mixotrophic and heterotrophic growth in which the microalgal cells are fed organic substrates such as glucose or acetate are needed, see e.g., Zuniga, C. et al., 2018; Chang, R. L. et al., 2011. Microalgae production processes for these bioproducts are not widely considered due to gaps in basic understanding of the metabolism at genome-scale as well as to technological barriers including low productivities. It would be highly desirable if we could create new bioprocesses for D. salina and H. lacustris species using abundant sources of (see e.g., Zuniga, C. et al., 2018; Chang, R. L. et al., 2011) available from biological and chemical waste incineration plants and other flue gas sites in the US to capture waste (see e.g., Zuniga, C. et al., 2018; Chang, R. L. et al., 2011) and convert it to carbon neutral bioproducts. Additionally, we can use concentrated salt water from the desalination plant in San Diego that is suitable for the growth of the marine algae D. salina.

Metabolic models are knowledge-based mathematical representations of cellular functions at a genome-scale, comprised of all the interconnected reactions organized into pathways. This interconnectedness enables them to be used for various purposes, such as directing hypothesis driven discovery, contextualizing multi-omics datasets, predicting growth phenotypes, and designing culture media that increase growth rates and bioproduction (see e.g., Fang, X. et al., 2020; Zuniga, C. et al., 2016; Li, Chien-Ting et al., 2019). With the genome-scale metabolic models of D. salina and H. lacustris we would be able to simulate all modes of microalgal growth, namely photoautotrophy, heterotrophy, and mixotrophy. Photoautotrophy is the most common culture condition applied for microalgae cultivation of D. salina (see e.g., Tibocha-Bonilla, J. D. et al., 2018), while mixotrophy is more common for H. lacustris (see, e.g., Khazi, Mahammed Ilyas et al., 2021). Interestingly, the current carotenoid industry is carried out mainly under photoautotrophic conditions, opening the potential for improvement by exploiting mixotrophy (see e.g., Paniagua-Michel, J. et al., 2009). While D. salina was isolated for the first time more than 100 years ago (see e.g., Helena, Shifa et al., 2016), H. lacustris was only recently isolated in 2016 (see, e.g., Liu, Jinghua et al., 2016). Still, there is a remarkable amount of multi-omics data and prior work available for both species, including complete genome sequences of D. salina published late in 2017 (see, e.g., Polle, W. E. Juergen et al., 2017) and of H. lacustris published in 2019 (see e.g., Morimoto, Daichi et al., 2020).

### Systems Biology and Genome-Scale Metabolic Model

Systems biology is a holistic approach to understanding the complex interactions within an organism. It integrates data from multiple disciplines (genomics, proteomics, and other “omics” fields) that allows for a more encompassing view of biology (see e.g., Ge, H. et al., 2003). Instead of breaking down the cell by components and focusing on a single genetic process, this approach allows scientists to see how cellular components interact with each other. This philosophy integrates well with the study of metabolomics. Metabolomics aims to characterization and quantify all the small molecules within an organism compiling an analytical description of its complexities (see e.g., Nicholson, J. K. and Lindon, J. C., 2008). These intersecting concepts have led to the development and creation of metabolic modeling.

A genome-scale metabolic model (GEM) is a knowledge base converted into a metabolic network or mapping of an organism of interest. It is built using genome annotation, ‘omics’ data sets and reference knowledge (see e.g., Cuevas, D. A. et al., 2016). GEMs demonstrate the genotype-to-phenotype relationship through the simulation of flux distributions along the metabolic pathways. The metabolic pathways and systems that can be analyzed computationally increases with every new GEM (see, e.g., Thiele, I. and Palsson, B. O., 2010). A new GEM can either be automatically reconstructed or semi-automatically reconstructed. Both methods use automatic tools to create a model that connects protein coding genes from the target organism associating it with promoting a metabolic reaction, however for the semi-automatic method the created model is considered incomplete or a “draft”. After the draft model is created, it is re-evaluated and refined (see e.g., Thiele, I. and Palsson, B. O., 2010). This process is called manual curation. In particular, the metabolic functions and reactions collected in the draft reconstruction are individually evaluated against organism-specific literature (see e.g., Monk, J. et al., 2014). This manual evaluation is important since not all associations made by the automatic tools have a high confidence. Also, biochemical databases are mostly organism unspecific, listing enzyme activities found in various organisms, not all of which may be present in the target organism. Including organism-unspecific reactions in the metabolic model may affect its predictive behavior and capabilities (see e.g., Monk, J. et al., 2014). Once a model is completed, it can be mathematically tested and referenced to experimentally test for target metabolites (see e.g., Fang, X. et al., 2020). In the case of D. salina, we can use this GEM as a metabolic map to optimize the production of carotenoids.

### Modeling for Algae

Since the reconstruction of the first genome-scale metabolic model in 1995, around 6000 models have been reconstructed automatically or semi-automatically (see e.g., Passi, A. et al., 2021). However, only nine metabolic models for photosynthetic organisms have been manually curated (for example Chlorella, Chlamydomonas, Synechocystis, Phaeodactylum, Nannochloropsis). This collection does not include two microalgae of great interest for biotechnology applications, such as Dunaliella salina (see e.g., Tibocha-Bonilla, J. D. et al., 2018). D. salina is a model marine microalga with extremely halophilic capacity. It has one of the greatest known capacities to synthesize and accumulate the carotenoid, β-carotene. While other microalgae typically produce pigments in the range of 1 to 2% of dry weight, D. salina has been demonstrated to produce over 10% of dry weight in pigments (see, e.g., Ben-Amotz, Ami, 2003).

Microalgae can grow as autotrophs, heterotrophs or mixotrophs, see e.g., Lee, Yuan-Kun, 2001. These different growth modes affect the biomass composition of the organism. This is especially true for phototrophs that have a dynamic biomass composition between the light-dark cycles (day/night) experienced in their natural environments, see e.g., Zuniga, C. et al., 2018. Phenotypic states of microalgae can also vary in accordance with the growth phase or environment conditions. These variations in microalgal phenotypes can be accounted for by providing the model with multiple biomass functions. The biomass function is a way to simulate the growth of the target organism at a given phenotypic state, see e.g., Marinos, G. et al., 2020. Some metabolic pathways are only active under certain growth conditions and the different pathways can be analyzed by testing multiple biomass functions.

Eukaryotic microalgae contain different organelles, and the exact compartmentalization is species dependent, see e.g., Tibocha-Bonilla, J. D. et al., 2018. The same reaction may occur in two different compartments but be facilitated by different proteins. This is why it is important to consider where each enzyme/protein is localized in the cell. Accurate annotation of proteins and compartmentalization in the model is necessary for maximizing information content and gaining detailed knowledge about microalgal metabolism, see e.g., Ge, H. et al., 2003. A metabolic model's predictive capabilities is highly dependent on the accurate representation of metabolic exchange between organelles. Bioinformatic tools can be used to determine the localization of each protein and increase the quality of the metabolic model.

Dunaliella salina

Dunaliella salina is a single-celled green alga that thrives in high salinity conditions, up to 2.5 times ocean salinity. Its lack of a cell wall allows the cell to react to salinity changes in the environment, see e.g., Polle, Jürgen E. W. et al., 2020. D. salina can react to these changes by shrinking or swelling depending on the salt concentrations, see e.g., Hosseini Tafreshi, A. et al 2009. It has adapted to surviving in these halophilic environments by producing glycerol to maintain osmotic pressure within the cell, see e.g., Johnson, M. K. et al., 1968.

Under stressful conditions, D. salina enters carotenogenesis. This causes the production of high concentrations of carotenoids, specifically -carotene and 9-cis-carotene, accumulating to approximately 15% of cell dry weight, see e.g., Polle, Jürgen E. W. et al., 2020. This ability has made it very popular in industrial cultivation. β-carotene is a type of pro-vitamin A that can be used as an additive in human and animal nutrition. Also, due to its bright orange pigment, it is used as a coloring agent in many cosmetics, see e.g., Hosseini Tafreshi, A. and Shariati, M., 2009. 9-cis-carotene is a compound that has a high antioxidant potency. This antioxidant property has shown to have a beneficial effect on human diseases such as retinitis and atherosclerosis, see e.g., Delman, Shahar et al., 2021; Ben-Amotz, A. et al., 1998. In recent years, there has been an increasing demand on pigments from natural sources driven by their potential nutritional and therapeutic use as antioxidants and anti-inflammatories, see e.g., Ambati, R. R. et al., 2019. This can potentially lead to the utility of Dunaliella salina becoming a food and nutritional supplement.

Phenotypes of Dunaliella salina were observed during experimental analysis. These samples were grown photoautotrophically in Artificial Seawater Medium (ASW) with 8.5% w/w NaCl. The samples are arranged from earliest in growth to latest in the growth stage) noted by their changing phenotypes. The green phenotype was observed during the exponential phase, the orange phenotype was observed during the stationary phase and the yellow phenotype was is observed as a transitional stage between the two.

During culture growth, three distinct phenotypes can be observed (green, yellow, orange). The phenotypes indicate the pigment concentrations, specifically carotenoids, that have accumulated in the chloroplast. The green phenotype has a low concentration of carotenoids and high concentration of chlorophyll, approximately 1:2. The yellow phenotype shows a decrease in chlorophyll and increase in carotenoid production, approximately a 4:1 ratio. The orange phenotype has a high concentration of carotenoids and low concentration of chlorophyll, approximately 17:1. By understanding the chemical composition of each phenotype, a genomic-scale metabolic model can be utilized to better simulate growth and provide insights on how to optimize carotenoid and antioxidant production.

### Materials and Methods

The reconstruction of genome-scale metabolic networks is carried out through the development and application of several algorithms (draft model generation, manual curation, gap-filling and validation). The generation of the draft model uses automatic tools and previous metabolic models as base for a new organism. For manual curation, available biochemical, see e.g., Kanehisa, M. et al., 2014, fluxomic, metabolomic, see e.g., H, Lv and X, Cui, 2016, physiological, see e.g., Capa-Robles, W. et al., 2009, proteomic and transcriptomic, see e.g., He, B. et al., 2018, databases were leveraged to build and test the model. Model validation was performed by including physiological and metabolomics data. Models can be improved and updated as new research and information is discovered.

### Characterization of Biomass Composition and Flavor Profiling

### Biomass Equation

To develop a biomass equation that reflects the composition of Dunaliella salina, experimental tests were run in-house. The chemical composition of D. salina cultures in Artificial Seawater Medium (ASW) with 8.5% w/w NaCl was determined following standard procedures for total, protein (see e.g., Modified Lowry method), total carbohydrate (Phenol-Sulphuric acid method), glycerol (see e.g., Hantzsch-Malaprade method), and total lipid (gravimetric method) content, see e.g., The content of DNA and RNA was determined following the instructions of Qiagen blood and tissue DNeasy and RNeasy purification kits. Furthermore, the amino acid, pigment, and fatty acid profiles were determined via ion-exchange liquid chromatography, high-performance liquid chromatography, and gas chromatography with flame ionization detection, respectively. The biochemical composition of at least 4 biological replicates was determined for cultures at day 7 (green phenotype), day 15 (yellow phenotype), and day 25 (orange phenotype). All cultures were maintained inside a shaking Innova 44 incubator at 85 rpm and 27.5° C. The incubator was illuminated with white, fluorescent lamps providing 100 μmol m-2 s-1 with 18 hours light-6 hours darkness cycles. Global biomass composition fractions resulted from dividing the concentration of a given component by the total biomass density, which was determined gravimetrically.

The biomass objective function (BOF) is another reaction in the GEM model that accounts for characterized biomass components within the cell. To obtain a BOF equation, the biomass composition fractions need to be translated into stoichiometric coefficients (in mmol/gDW) for each metabolite after dividing the mass fractions (in mg/gDW) by the corresponding molecular weight (in mg/mmol). In general, the BOF lists the terminal metabolites in the metabolic network that characterize the biomass under a given condition. Remarkably, when a BOF is properly calculated the resulting molecular weight of the biomass should be 1000 mg/mmol, see e.g., Chan, S. H. J. et al., 2017.

Determining the individual mass fraction of each metabolite listed in the BOF equation required the combination of data from multiple sources. The biomass fraction of the twenty proteinogenic amino acids was determined by combining total protein fractions with the amino acid analyzer results. Since L-Glutamine and L-Asparagine cannot be determined experimentally, the corresponding fractions of these amino acids were deducted from the L-Glutamate and L-Aspartate pools, using reference values reported for Chlamydomonas as a result of nitrogen exhaustion, see e.g., Paul, J. H. and Cooksey, K. E., 1981. The biomass fraction of individual lipids was estimated by combining the experimental fatty acid profile results with the lipid profiles reported for whole Dunaliella cells, see e.g., Fried, Adina et al., 1982; Sheffer, Meir et al., 1986; Vrana, Ivna et al., 2022; Samburova, Vera et al., 2012; Peeler, T. C. et al., 1989. This was necessary because the fatty acids are distributed across different types of lipids that compose the thylakoid, and cellular membranes, namely digalactosyldiacylglycerol (DGDG), diacylglyceryltrimethylhomo-serine (DGTS), monogalactosyldiacylglycerol (MGDG), Phosphatidylcholine (PC), phosphatidylethanolamine (PE), Phosphatidylglycerol (PG), Sulfoquinovosyl diacylglycerol (SQDG), and triacylglycerol (TAG). Considering the previously reported contents of these lipids in Dunaliella, the mass fractions of the lipids for each growth stage were assigned ensuring the mass balance of the fatty acids in the cell. The biomass fraction of the nucleotides in the nucleic acid fractions (RNA and DNA) was determined by analyzing the global composition of Dunaliella salina CCAP 19/18 genome, see e.g., Polle, W. E. Juergen et al., 2017. While this analysis provided the molar fractions of DNA nucleosides (i.e., deoxythymidine (T), Deoxycytidine (C), Deoxyadenosine (A), and Deoxyguanosine (G)), the molar fractions of RNA nucleosides were estimated from the DNA fractions. The pigment mass fractions were obtained directly from the liquid chromatography reports, considering that up to 10 different pigments were detected in Dunaliella biomass, namely Neoxanthin, Violaxanthin, Antheraxanthin, Lutein, Lutein epoxide, Chlorophyll b, Chlorophyll a, α-Carotene, β-Carotene, and 9-cis-β-Carotene. Finally, the carbohydrate mass fractions were estimated by combining the total carbohydrate determination results with previously reported data on sugar composition of D. salina, which contained D-Mannose, D-Ribose, Glucuronic acid, α-D- and β-D-Glucose, D-Galactose, D-Xylose, and L-Arabinose, see e.g., Dai, Jun et al., 2010. The translation of biomass composition fractions into biomass coefficients allowed the preparation of three BOF, representing the three phenotypes green, yellow and orange, that the model optimizes during flux-balance analysis.

The biomass objective function (BOF) is one of the most critical reactions in a metabolic model. It accounts for all metabolites characterized within the cell. To obtain a BOF measured biomass composition fractions need to be translated into stoichiometric coefficients (in mmol/gDW) for each metabolite after diving the mass fractions (in mg/gDW) by the corresponding molecular weight (in mg/mmol). In general, the BOF lists the terminal metabolites in the metabolic network under a given condition. For D. salina we identified three metabolic states. Determining the individual mass fraction of each metabolite listed in the BOF equation required the combination of data from multiple sources. We used our chromatographic methods funded by BRC-BIO to characterize lipids.

### Culture Conditions

The chemical composition of D. salina cultures in Artificial Seawater Medium (ASW) with 8.5% w/w NaCl was determined following standard procedures for total, protein (Modified Lowry method), total carbohydrate (Phenol-Sulphuric acid method), glycerol (Hantzsch-Malaprade method), and total lipid (gravimetric method) content. The content of DNA and RNA was determined following the instructions of Qiagen blood and tissue DNeasy and RNeasy purification kits. Furthermore, the amino acid, pigment, and fatty acid profiles were determined via ion-exchange liquid chromatography, high-performance liquid chromatography, and gas chromatography with flame ionization detection, respectively. The biochemical composition of at least four biological replicates was determined for cultures on day seven (green phenotype), day 15 (yellow phenotype), and day 25 (orange phenotype). All cultures were maintained inside a shaking Innova 44 incubator at 85 rpm and 27.5° C. The incubator was illuminated with white-fluorescent lamps providing 100 μmol m-2 s-1 with 18 hours light-6 hours darkness cycles. Global biomass composition fractions resulted from dividing the concentration of a given component by the total biomass density, which was determined gravimetrically.

### Proteins

The biomass fraction of the twenty proteinogenic amino acids was determined by combining total protein fractions with the amino acid analyzer results. Since L-Glutamine and L-Asparagine cannot be determined experimentally, the corresponding fractions of these amino acids were deducted from the L-Glutamate and L-Aspartate pools, using reference values reported for Chlamydomonas as a result of nitrogen exhaustion.

### Carbohydrates

The pigment mass fractions were obtained directly from the liquid chromatography reports, considering that up to 10 different pigments were detected in Dunaliella biomass, namely Neoxanthin, Violaxanthin, Antheraxanthin, Lutein, Lutein epoxide, Chlorophyll b, Chlorophyll a, α-Carotene, β-Carotene, and 9-cis-β-Carotene.

### Fatty Acid Analysis

The biomass fraction of individual lipids was estimated by combining the experimental fatty acid profile results with the lipid profiles reported for whole Dunaliella cells. Using this information the fatty acids were distributed across different types of lipids that compose the thylakoid, and cellular membranes, namely digalactosyldiacylglycerol (DGDG), diacylglyceryltrimethylhomo-serine (DGTS), monogalactosyldiacylglycerol (MGDG), Phosphatidylcholine (PC), phosphatidylethanolamine (PE), Phosphatidylglycerol (PG), Sulfoquinovosyl diacylglycerol (SQDG), and triacylglycerol (TAG). Considering the previously reported contents of lipids in Dunaliella, the mass fractions of the lipids for each growth stage were assigned ensuring the mass balance of the fatty acids in the cell.

### Pigments

The pigment mass fractions were obtained directly from the liquid chromatography reports, considering that up to 10 different pigments were detected in Dunaliella biomass, namely Neoxanthin, Violaxanthin, Antheraxanthin, Lutein, Lutein epoxide, Chlorophyll b, Chlorophyll a, α-Carotene, β-Carotene, and 9-cis-β-Carotene.

### Nucleic Acids

The biomass fraction of the nucleotides in the nucleic acid fractions (RNA and DNA) was determined by analyzing the global composition of Dunaliella salina CCAP 19/18 genome. While this analysis provided the molar fractions of DNA nucleosides (i.e., deoxythymidine (T), Deoxycytidine (C), Deoxyadenosine (A), and Deoxyguanosine (G)), the molar fractions of RNA nucleosides were estimated from the DNA fractions.

### Mixotrophic Growth

Colonies from solid slants of D. salina and H. lacustris were cultured for two weeks into 100 ml of in Artificial Seawater (ASW) and Bold Basal Media with 3-fold Nitrogen and Vitamins (3N-BBM+V) in 250 mL flasks, respectively. Subsequently, we evaluated growth phenotypes in a high-throughput manner using BIOLOG phenotype microarrays for microorganisms. Each microplate contains 95 distinct carbon (PM1) or nitrogen (PM3) sources, allowing for a comprehensive assessment of 190 environmental conditions. Therefore, five milliliters of inoculum from the original culture were washed two times in ASW or BBM without NaNO3 (starvation medium) and left in starvation overnight. The overnight culture was transferred in PM1 and PM3 (starvation medium supplemented with 0.84 g/L of NaHCO₃) media, reaching an OD 680 of 0.1. OD 680 indicates the concentration of chlorophyll in algae, which can be correlated with biomass density. Finally, 100 uL of PM1 and PM3 media with algae were inoculated in each well of their respective microplate and incubated on a rotatory shaker (85 rpm) at 27° C. for 167 h. The incubation cycle consisted of 18 hours of light and 6 hours of dark per day.

This approach was applied to get different growth curves of D. salina and H. lacustris under several environmental conditions, for carbon sources and for nitrogen sources. We utilized the modified Gompertz model to fit each growth curve to the observed growth data accurately.

### Draft Generation

Previously Dr. Zuniga published the genome-scale metabolic model for Chlorella vulgaris UTEX 395 (iCZ843), the most comprehensive model for any eukaryotic photosynthetic organism, see e.g., Zuniga, C. et al., 2016, using this model we created draft models of D. salina and H. lacustris. Those models are developed to predict metabolic capabilities over the course of growth and under stress conditions. First, we performed genome analysis of the of the assembled genomes of D. salina and H. lacustris; these are performed using the available complete genome sequences of D. salina, NCBI GCA_002284615.1 and H. lacustris NCBI GCA_011766145.1. The draft consisted of 2,295 reactions and 1,770 metabolites. Gene-Protein-Reaction (GPR) associations were made for 82% of the reactions, 61% associated to D. salina and 21% were kept from C. vulgaris. The exogenous associations, the ones connected to C. vulgaris, were addressed during refinement.

### Semi-Automatic Reconstruction and Model Simulation

The GEM for Dunaliella salina was built using the semi-automatic reconstruction method. The reconstruction algorithmic tools used to create the draft model were THE CONSTRAINT-BASED RECONSTRUCTION AND ANALYSIS TOOLBOX™ (COBRA™), see e.g., Heirendt, L. et al., 2019} [24] and Reconstruction, Analysis, and VISUALIZATION OF METABOLIC NETWORKS TOOLBOX™ (RAVEN™), see e.g., Agren, R. et al., 2013. To create the high-quality draft model the FASTA™ formatted proteome of the Dunaliella salina (NCBI GCA_002284615.1) and the genome and metabolic network of Chlorella vulgaris (NCBI LDKB00000000.1) was provided as input, see e.g., Zuniga, C. et al., 2016. This template was chosen because C. vulgaris is a highly annotated model that was built using Chlamydomonas reinhartii, see e.g., Chang, R. L. et al., 2011, a green alga closest phylogenetically to D. salina. Each reaction and its associated protein from the template model were evaluated against the proteins from D. salina. The BLASTp™ parameters set by RAVEN™ Toolbox, the E-value, identity, and query coverage cut-offs are 1e-30, 40%, and 50%, respectively, this controls the connection known as gene-protein-reaction (GPR) associations. These connections determine if D. salina has a protein that can facilitate the given reaction. Once all reactions are reviewed automatically using RAVEN™ toolbox, the output is a draft model.

### Model Simulations

Simulations are performed using the Gurobi Optimizer Version 5.6.3 (Gurobi Optimization Inc.) solver in MATLAB™ (The MathWorks Inc.) with the COBRA™ toolbox (Schellenberger et al., 2011). Flux Balance Analysis (FBA) is used to simulate the genome-scale model (Orth et al., 2010). To scan the solution space, to calculate flux ranges for each reaction, and to determine active reactions under the simulated conditions in the metabolic model, Flux Variability Analysis (FVA) and random sampling of the metabolic model solution space were used. To uniformly sample the solution space of iCZ843, OPTGPSAMPLER™ (Megchelenbrink et al., 2014) for MATLAB™ with GUROBI OPTIMIZER VERSION 6.5.0™ was used. The BOF was fixed to 90% and 100% of the predicted growth rates to better characterize the solution space. Before sampling, all reactions that could not carry flux under the simulated conditions were removed from the models using FVA. The reduced models were sampled with 50,000 sample points and a step count of double the number of reactions in the corresponding model. Reactions carrying an absolute flux lower than 10⁻¹⁰ were set to zero.

### Identify Limiting Metabolites Using Model Simulations

To vary biomass profiles, we can build up to six different algae models with biomass composition for C. vulgaris and D. salina. Biomass composition data are collected. Next, can apply the GEM to determine which inputs or pathways are limiting the generation of specific protein and pigment profiles. In a preliminary evaluation, we specified potential key limiting metabolites using the iCZ947 metabolic network. We simulated six functional states with varying biomass compositions. Out of 1,771 metabolites in the model, we identified 35 candidate intracellular metabolites that may limit alga cell growth. Examples of these metabolites are pantoate and jasmonic acid as described in the preliminary results. We can perform simulations for each scenario and microalgae increasing the accumulation of the amino acids, e.g., aspartic acid, arginine, alanine, cysteine, glycine, glutamic acid, and methionine as well as in the nucleotides GMP, IMP, and AMP.

### Create Metabolite Supplement Cocktails

Perturbations to the amino acids and pigments profiles have been shown to lead to changes in biomass composition. Metabolites deploying the largest impact on growth rate and nutrients productivities for different profiles are selected. We can then consider different potential nutrient supplements and rank-order their strength on growth and nutrients profile phenotypes in simulations. A subset of these nutrients are tested experimentally for efficacy as media supplements.

### Optimize Nutrient Levels Through Scale-Up Algorithms

Once we have applied the genome model and varied feedings to achieve a desirable biomass profile, we apply our GEM using a nutrient optimization algorithm in order to provide enough nutrient components and ensure that we are feeding their proper concentrations. With this algorithm, the growth rate is used as an input and the objective function is altered such that the goal is to utilize optimize the amount of nutrients consumed to ensure a robust growth target. In this way, we can provide the ideal amount of nutrients while not adding excesses in order to limit biomanufacturing cost and ensure achieving a desirable final biomass profile.

This information can be subsequently used to predictively control nutrient feeding. The real-time metrics of pH, dO₂, temperature, light intensity, and CO₂ levels enabled a more robust control strategy minimizing superfluous nutrient use and maximizing lipid accumulation. The control algorithm connects the process data with a genome-scale metabolic model in order direct control changes and their impact on output biomass quantity and protein, lipid or pigments product yields.

This is especially exciting because algae-based food scientists can dial in the composition of the amino acids and pigments in order to change what tastes are achieved while providing precise amounts of nutrients needed to generate target flavors, making the product more affordable and palatable for consumers.

Finding Connections Among Flavor and Metabolic Stage of D. salina
Identification of Volatiles by Headspace Solid-Phase Microextraction Combined with Gas Chromatography-Mass Spectrometry-Olfactometry (HS-SPME-GC-MS-O)

The volatile organic compounds (VOCs) of different microalgae samples (10% slurry in water, w/v) are analyzed using a 8890 GC™ system (Agilent) attached to a 5977C MSD™ system and coupled with a GERSTEL™ olfactory detection port (ODP). The character-impact flavor and off-flavor compounds are identified based on the olfactometry results and further quantified using a standard curve of corresponding standards.

### Mechanism of Off-Flavor Formation

To study the formation mechanism of off flavors in microalgae species, a carbohydrate module labeling technique are used (Xu et al., 2013). We can use a 1:1 ratio of fully labeled and unlabeled reducing sugars (D-xylose or D-ribose) to understand the inside chemistry of the off-flavor compounds and the formation pathways of the Maillard reaction products of microalgae species. A Maillard reaction is performed using a ¹³C₅ D-xylose model system. The Maillard reaction products are analyzed through GC-O-MS and the formation pathways of the off-odorants are projected by tracing the GC-O-MS mass spectrograms of each off-odorants. The mass signal fragments of the labeled sugar [¹³C₅] D-xylose are compared to the unlabeled D-xylose. By tracing the mass fragments of the labeled and unlabeled reducing sugars, we can get insights about the formation pathways and the production mechanisms of off flavors in microalgae species and its Maillard reaction products, see e.g., Helena, Shifa et al., 2016.

### Results

### Manual Curation Workflow

Then, we started the manual curation process. The metabolic network of D. salina has been manually curated for almost one year now. Manual curation is the refinement of the draft model using bioinformatic databases and organism-specific literature. During this stage, a workflow was developed and implemented to connect gene identifiers to a reaction in the model. The first strategy during manual curation was to search the proteome to connect protein functions with reactions. This strategy was not sufficient since most of the proteins were not annotated with functions and simply labeled “hypothetical protein”. A new method was developed and implemented to find the GPR associations. We have also implemented various machine learning algorithms such as DEEPLOC™¹⁷ to facilitate the allocation of reactions in different compartment. The full list of resources is provided in Table 1.

### Manual Curation

Manual curation is the refinement of the draft model using bioinformatic databases and organism-specific literature. During this stage, a workflow was developed and implemented to connect gene identifiers to a reaction in the model. The first strategy during manual curation was to search the proteome to connect protein functions with reactions. This strategy was not sufficient since most of the proteins were not annotated with functions and simply labeled “hypothetical protein”. A new method was developed and implemented to find the GPR associations.

Workflow of manual curation and protein localization developed to find GPR associations. Starting with the draft model, a reaction is selected to review. The reaction is located in BIGG™ (see, e.g., King, Z. A. et al., 2016) with the ultimate goal to locate a protein sequence for the enzyme that drives the reaction. This is done by using other metabolomics databases listed in Table 1. Once a sequence is found, a BLASTp™ is run against D. salina genome. GPR associations are determined based on BLASTp™ results.

First, the reaction ID was located in BiGG™ {King, Z. A. et al., 2016} [28], the database used to create the draft model. BiGG™ entries show the reaction formula, models containing the reaction, and external links to other databases with additional information. The goal was to retrieve a protein amino acid sequence from phylogenetically close organisms using the enzyme number or name. Several resources were used during the manual curation phase, such as primary literature and the databases BiGG™, see, e.g., King, Z. A. et al., 2016, see, e.g., KEGG™ Kanehisa, M. and Goto, S., 2000, IntEnz, see, e.g., Fleischmann, A. et al., 2004, ModelSEED, see, e.g., Seaver, S. M. D. et al., 2021, ENZYME@ExPASy™, see, e.g., Bairoch, A., 2000, and UNIPROT™ (UniProt, Consortium, 2023). Information regarding transport proteins were obtained from Transporter Classification (TC) Database (TCDB), see, e.g., Saier, M. H., Jr. et al., 2006. Once an amino acid sequence for the enzyme that promotes the given reaction was found, it was then compared against the proteome of the target organism using NCBI BLASTp™, see, e.g., Boratyn, G. M. et al., 2013. After obtaining the BLASTp™ results, gene identifiers were assigned to the GPR based on my discretion. Each result was evaluated based on E-value, query cover, percent identity and alignment. A smaller E-value, higher query coverage and higher percent identity indicated a good match for the GPR association. If no match was found then the GPR association was left blank, in order to be readdressed later. The lack of a homologous match might be due to missing genetic information (an empty GPR is added) or a falsely added reaction (the reaction is removed). Ultimately, the model contributes to the update of the genome annotation through the GPR associations.

### Protein Localization and Genome Annotations

The genome of D. salina had a large portion of “hypothetical proteins”. These proteins lacked functional annotations and descriptions. The process of manual curation increased the genome functional annotations. Functions for 227 genes labeled as “hypothetical proteins” were found during manual curation. Additionally, with the information gathered indicating protein localization, we can also identify what compartment these enzymes are located.

Since Dunaliella salina is a eukaryotic cell, protein compartmentalization was also considered when assigning gene identifiers to GPR associations. Protein localization and comparison of the whole proteome was completed before manually curating the draft model. Localization tools, TARGETP™, see, e.g., Emanuelsson, O. et al., 2000, HECTAR™, see, e.g., Gschloessl, B. et al., 2008, DEEPLOC™, see, e.g., Almagro Armenteros, J. J. et al., 2017 and PREDALGO™, see, e.g., Tardif, M. et al., 2012, were utilized to determine signal peptides, chloroplast and mitochondria localization of the proteins. Multiple localization tools were run to compare outcomes. After a BLASTp™ search is run, the found gene identifiers can be compared to the predicted localization and added as the GPR association if the given reaction location matches. For example, this prevented chloroplast-localized enzymes from being added to mitochondrion reactions, resulting in a more accurate model.

### Gap Filling

Once manual curation was complete, the model was further refined with a process called gap filling. This process increases the accuracy of growth simulations in the model, see, e.g., Bernstein, D. B. et al., 2021. Gap-filling was implemented to detect missing reactions of a specific metabolic pathway that showed growth in-vitro. The growth experiments tested the utilization of carbon and nitrogen sources by Dunaliella salina. If D. salina can utilize that metabolite, there was evidence of cell growth. The growth conditions from the experiments were then simulated in-silico and the model's predicted growth was obtained using flux-balance analysis. Flux-balance analysis (FBA) is a computational method used in metabolic modeling by predicting the flow of metabolites through a metabolic network, see, e.g., Orth, J. D. et al., 2010. Additionally, for D. salina targeted metabolomics data was available for lipid profiling, reactions, and genes. Metabolites were created in order to enable the network to simulate experimentally observed phenotypes.

To identify gaps in the model an FBA was run and experimental tests of growth on different carbon and nitrogen sources as well as targeted metabolomics profiling were performed. FBA optimizes a particular objective function to determine the distribution of metabolic fluxes, see, e.g., Orth, J. D. et al., 2010. This approach enables the study of cellular metabolism under various conditions, including photoautotrophically, mixotrophically and heterotrophically, providing insights into the metabolic capabilities and potential bottlenecks of an organism, see, e.g., Thiele, I. and Palsson, B. O., 2010. By setting the conditions in-silico to emulate the experimental conditions, the same carbon sources and nitrogen sources can be tested. The flux results of each metabolite were then compared to the in-vitro growth results.

Comparisons result in one of four outcomes: true positive (TP, positive growth in vitro and in silico), true negative (TN, negative growth in-vitro and in-silico), false positive (FP, negative growth in vitro and positive growth in silico), and false negative (FN, positive growth in vitro and negative growth in silico). A common metric used to evaluate the accuracy and prediction capabilities of a metabolic models is the Matthews Correlation Coefficient (MCC). MCC calculation can be performed for gene essentiality and growth phenotypes by comparing in vitro and in silico analysis. With this approach, Equation 1.1 can be used to estimate the MMC.

$$MCC = ( TN \times TP - FN \times FP ) / √ ( ( TP + FP ) ( TP + FN ) ( TN + FP ) ( TN + FN ) )$$

In order to increase the accuracy of the model, both the false positive and false negative metabolites needed to be addressed. If a metabolite resulted as a false positive, the extracellular transport reaction was removed to ensure the model reflected the negative growth seen in vitro. False negative metabolites needed additional pathways to ensure the model can reflect the positive growth. The correct pathways to add were decerned from literature and by use of KYOTO ENCYCLOPEDIA OF GENES AND GENOMES™ (KEGG™) pathways. For every new reaction added, the model's flux was reevaluated to ensure that the model still showed growth.

### Reconstruction

### Genome Annotation was Enhanced Through the Manual Curation of the Metabolic Network

The draft model for Dunaliella salina was built using the COBRA™ and RAVEN™ Toolboxes. Using the genome annotation D. salina CCAP 19/18 (NCBI GCA_002284615.1) and existing genome-scale model of C. vulgaris (iCZ843) as input, a draft was assembled based on protein homology. The draft consisted of 2295 reactions and 1770 metabolites. Gene-Protein-Reaction (GPR) associations were made for 82% of the reactions, 61% associated to D. salina and 21% were kept from C. vulgaris. The exogenous associations, the ones connected to C. vulgaris, were addressed during refinement.

Each reaction was reevaluated using the manual curation. Since the automatic tools have a rigid cutoff, the reevaluation allowed for a more accurate GPR association. Over the course of 9 months, every reaction was reviewed using metabolomics and genome information compared to better studied organisms. Reaction and metabolite information was updated to current identifiers and EC numbers. After manual refinement of the model, GPR associations for D. salina were increased to 78% and exogenous associations were reduced to 5%. The unassociated reactions predominately consist of exchange and transport reactions. Further GPR refinement was made by comparing protein localization data to the reaction compartment. This increased the quality of the model regarding the GPRs associated to the same reactions occurring in multiple compartments.

The genome used for model refinement had a large portion of “hypothetical proteins”. These proteins lacked functional annotations and descriptions. The process of manual curation also increased the genome functional annotations. The GPR associations were used to update the protein descriptions. Also, with the information gathered indicating protein localization, the compartmentalization of these enzymes can be identified.

### Construction of Biomass Equations

Generation and validation of genome-scale metabolic models requires a remarkable amount of data. This data is useful to create parameters also referred to as “constraints”. The accuracy of model simulations heavily relies on experimental measurements. For example, for D. salina we identified the characteristic physiological states over the course of photoautotrophic growth. During this aim we have measured the biomass composition of D. salina as well as performed full phenotyping.

The biomass objective function (BOF) accounts for most of the known biomass constituents discovered through experimental analysis or previous research. These components are added in terms of their fractional abundance per gram of biomass. This project resulted in three biomass equations representing the three observed phenotypes (green, yellow, orange) of Dunaliella salina. Carbohydrates and pigments increased across the phenotypes, while lipids and glycerol concentrations decreased. Those breakdowns resulted in a variation in metabolites between the three phenotypes. Lipid profiles of the three biomass functions differ. The concentration of lipid metabolites represented in the biomass was compared. Both monogalactosyldiglycerol (MGDG) and digalactosyldiglycerol (DGDG) have a higher concentration in the green and yellow biomass compared to the orange. There were commonalities in the metabolites. The green biomass contains 270 metabolites, 217 being lipids. The yellow biomass contains the most metabolites at 482, with 429 lipids. Finally, the orange biomass contains the least amount at 265 metabolites and 212 are lipids. These resulting compositions can allow the model to accommodate the changing biomass seen during the growth cycle of D. salina.

### Refinement and Expansion

During the manual curation we added reactions, metabolites, and genes for the synthesis of odd chain fatty acids. A total of 601 metabolites and 893 reactions were added to the model. Those reaction were added for the first time to any algae and genome-scale metabolic model. We performed this task based on our experimental evidence collected in Aim 2 and by researching and analyzing the pathways of even-chain fatty acid synthesis in other databases. Instead of acetyl-[acp] reacting with malonyl-[acp] to begin synthesis, odd-chain synthesis begins with propionyl-[acp] increasing the initial chain by one carbon. Synthesis pathways to create chains C5:0 to C21:0 were used as building blocks for lipids in the biomass. Once the odd-chain fatty acids were added, lipidomics data from previous experimental studies, were used to quantify the lipid profiles needed in the model. Additional pathways and lipid metabolites were built with odd-chain fatty acids and added to the model to be produced in the biomass composition. Overall, the model currently contains all the lipids that D. salina can produce. They are grouped in the esters: triacylglycerol (TAG), phosphatidylglycerol (PG), phosphatidylinositol (PI), phosphatidylethanolamine (PE), sulfoquinovosyldiglycerol (SQDG), monogalactosyldiglycerol (MGDG), digalactosyldiglycerol (DGDG), and phosphatidylcholine (PC). Fatty acids in these esters commonly fall into seven major groups: C16:0, C16:1, C16:2, C16:3, C18:1, C18:2, and C18:318. The metabolic model already encompassed pathways to synthesize each of these lipids. Using the experimentally determined fatty acid values, a theoretical categorization of the groups of lipids was conducted according to a previous study19. Additional even-chain fatty acids, specifically lipids with C18:0 and C14:0 chains do not present in the C. vulgaris model, were also added for a more comprehensive biomass equation. Synthesis of lipids already in the model were analyzed and replicated to include the correct fatty acid chain and unsaturation. Once all lipid metabolites were added to the model, three biomass objective functions, representing experimental analysis of the three phenotypes, were drafted.

### Gap Analysis

Once manual curation was complete, the model was further refined with a process called gap filling. To increase the accuracy of growth simulations in the model the concept of gap-filling was used. Gap-filling was implemented to detect missing reactions of a specific metabolic pathway that showed growth in-vitro (Aim 2). The growth experiments tested the utilization of carbon and nitrogen sources by D. salina. If D. salina can utilize that metabolite, there is evidence of cell growth. The growth experiments were then simulated in-silico, using FLUX-BALANCE ANALYSIS™ (FBA™). FBA™ is a computational method used in metabolic modeling to predict the flow of resources through a metabolic network. Additionally, for D. salina targeted metabolomics data was available for lipid profiling, reactions, and genes. Metabolites were created in order to enable the network to simulate experimentally observed phenotypes.

To identify gaps in the model we run FBA™, experimental tests of growth on different carbon and nitrogen sources as well as targeted metabolomics profiling were performed. D. salina grew under 34 of the 190 carbon sources and 13 of 95 nitrogen sources tested.

FBA™ enabled the study of cellular metabolism under various conditions, providing insights into the metabolic capabilities and potential bottlenecks of an organism. By setting the conditions in-silico, the same carbon sources and nitrogen sources can be tested. The flux results of each metabolite were then compared to the in-vitro growth results.

Comparisons between experimental and predicted phenotypes result four possible outcomes: true positive (TP, positive growth in vitro and in silico), true negative (TN, negative growth in vitro and in silico), false positive (FP, negative growth in vitro and positive growth in silico), and false negative (FN, positive growth in vitro and negative growth in silico). A common metric used to evaluate the accuracy and prediction capabilities of metabolic models is the Matthews Correlation Coefficient (MCC). MCC calculation can be performed for gene essentiality and growth phenotypes by comparing in vitro and in silico analysis. With this approach, Equation 1 can be used to estimate the MMC.

$$MCC = ( TN \times TP - FN \times FP ) / √ ( ( TP + FP ) ( TP + FN ) ( TN + FP ) ( TN + FN ) ) \qquad ( Eq . 1 )$$

In order to increase the accuracy of the model, both the false positive and false negative metabolites needed to be addressed. If a metabolite resulted as a false positive, the extracellular transport reaction was removed to ensure the model reflected the negative growth seen in vitro. False negative metabolites need additional pathways to ensure the model can reflect the growth. The correct pathways to add were discerned from literature and by use of KEGG™ pathways. For every new reaction added, the model's flux was reevaluated. Every new reaction has the potential to “kill” the model, preventing it from growing. When reflected in the model and compared, this resulted in a Matthews Correlation Coefficient (MCC) of 0.52. Original tests showed 19 false positive (FP) metabolites (Table 2). By analyzing those metabolite pathways, FP outcomes were able to be reduced to 2 metabolites. When looking at false negative (FN) metabolites the model only had 4 to fix. These pathways were reviewed; however, the additions and changes did not alter the growth. Since the accuracy and MCC calculations have already improved significantly, other important pathways and metabolites that contribute to the biomass composition were prioritized.

Flux Balance Analysis is a widely used tool for interrogating metabolic models and to calculate an optimal network state given by a particular flux distribution while maximizing an objective function. Commonly, the production of biomass is modeled as an objective function. FBA optimizes a particular objective function to determine the distribution of metabolic fluxes. The biomass objective function (BOF) is implemented into the model as a reaction that pulls resources from the metabolic network and defines all known cellular components (such as amino acids, nucleotides, fatty acids, carbohydrates, vitamins, ions, and cofactors) and their fractional contributions. Each constrained metabolite in the BOF affects the reaction activity in the network and hence the final flux distribution and solution space. We have analyzed the experimentally determined biomass composition of D. salina over time under photoautotrophic growth. Defining dynamic BOFs enabled us to highly improve the growth rates predictability of the genome-scale model for this alga and to gain detailed insight into the dynamic proteome demand of the organism. The constraints applied to the model resulted in the prediction of flux through reactions over the course of growth that are necessary to produce biomass. Experimental results also indicated a critical metabolic node that will increase biomass by synthesizing odd chain fatty acids. The knowledge of how CO₂ and abiotic parameters affect algal culture environment and pigment composition is critical when optimizing growth of D. salina.

### Model Simulations

### Model Properties

The metabolic model for Dunaliella salina has a total number of 3,225 reactions, 2,438 metabolites and 938 genes. Fatty acid metabolism makes up nearly half of the total reactions. This is important for the development of all membrane lipids for the cell. The addition of the odd-chain fatty acid biosynthesis pathway allows for a more comprehensive model. This comprehensive synthesis allows the model to better simulate the flux through the metabolic model. Another important indicator of a highly comprehensive model is the number of reactions assigned to a GPR. These gene-protein-reactions associations is a gene assignment to a reaction in the model. This indicates that, within the genome of D. salina, there is a protein that facilitates the given reaction. This provides confidence that the reaction belongs in the model. Out of the 3225, 433 do not have a GPR assigned. Majority of these reactions are transport reactions where many of them are described as a “diffusion” reaction and do not need a protein to facilitate. In an ideal situation, all reactions present in the model would have a GPR, however it is limited by current information. As more biological processes are studied, the model for D. salina can be further refined, improving the quality.

By comparing this model to other metabolic models, we visualize how the reactions and biological systems overlap. We did a breakdown between the green alga C. vulgaris, see, e.g., Zuniga, C. et al., 2016, and two photosynthetic marine diatoms, Cylindrotheca closterium, see, e.g., Kumar, M. et al., 2024, and Phaeodactylum tricornutum, see, e.g., Levering, J. et al., 2016, in a Venn Diagram. Since the model for D. salina was built using C. vulgaris, it has the most reactions in common. The model for P. trichornutum has more reactions involved in lipid development for even-chain fatty acids. Due to this, iLB1027 was important in the addition of C14 lipids and other missing even-chain lipids for the metabolic model. The metabolic model for D. salina has a high number of unique reactions due to the addition of the odd-chain fatty acids.

In order to determine the properties and robustness of the metabolic model, analyses are performed for validation. Using MATLAB and the COBRA toolbox, a photoautotrophic media was simulated to test the growth and compare flux distributions. The model media included light photons produced by an incandescent 60 W light bulb, oxygen, carbon in the form of CO₂, and nitrate. In Table 4, we can see the predicted growth rates produced by the three biomass equations. All three are within the range seen in the experimental data.

By focusing on the flux of subsystems in the model, we can analyze how the biomass equations influence the optimization. We can see a comparison between the three biomass optimizations. The green and orange biomass have similar fluxes while the yellow fluxes are divergent. This suggests that the yellow phenotype is in a transitional environment. This is supported by the experimental evidence gained during this study. In the stages of development, the yellow phenotype occurs at day 15 after green (day 7) and before the orange (day 25). We constructed a heatmap that showed that the highest regulated reactions are more connected in the green and orange over the yellow biomass. Amongst the highest regulated reactions are ones involved in the glycolysis pathway. This pathway connects the synthesis for glycerol, glucose, lipids and carotenoids. The flux through this system dictates the production of metabolites. The biomass concentrations of carbohydrates and pigments show an increase across the three phenotypes, while lipids and glycerol show a decrease. These metabolites are interconnected at the glycolysis pathway that is identified by the highest flux regulation. This suggests that the glycolysis pathway is instrumental in deciding the tradeoff between the synthesis of glycerol, -carotene, lipids and glucose.

### Flavor Analysis

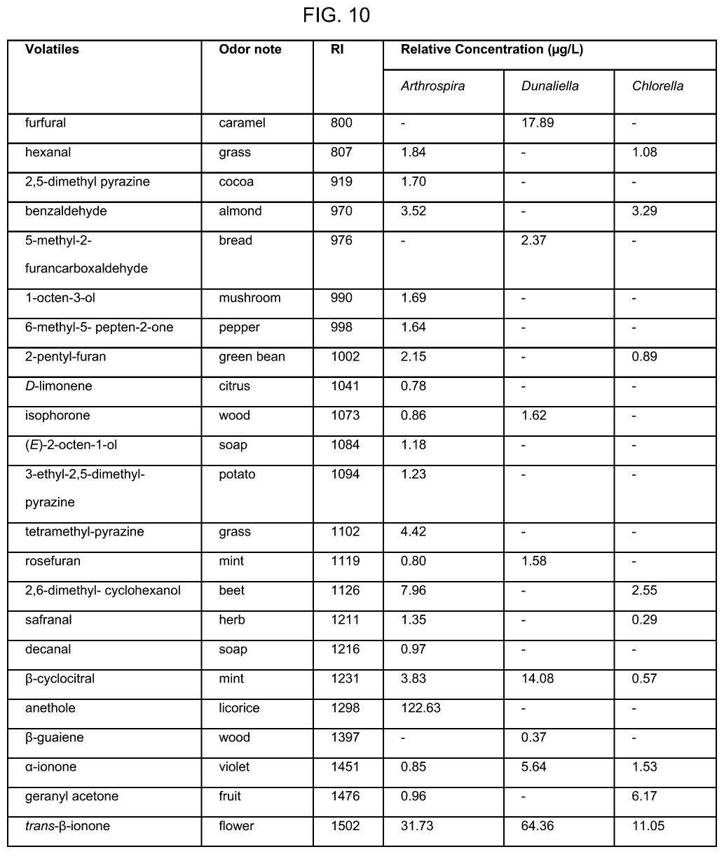

Table 1 (FIG. 10) shows select key aroma-active compounds identified in microalgae.

### Discussion

With this genome-scale metabolic model for Dunaliella salina, we can expand the metabolic space that can be computationally added. The accuracy of iJA938 is supported by the simulated growth rates and the low error rates when comparing the experimental growth. Experimental growth shows a 0.0239±0.043 hr-1 rate. The simulated growth for the green phenotype is 0.0245 mmol/g DW with an error rate of 2.9%. The simulated growth for the yellow phenotype is 0.0252 mmol/g DW with an error rate of 5.4%. The simulated growth for the orange phenotype is 0.0263 mmol/g DW with an error rate of 10%. It's important to note that GEM are more accurate at describing growth during the exponential phase. The yellow phenotype is a transitional stage, and the orange phenotype is the stationary phase of cellular growth. This is why you see an increased error for those stages. However, the model allows us to analyze the fluxes of metabolic reactions for the different phenotypes.

Experimentally we can see the changing phenotypes over the growth phases. In the stages of development, the green phenotype occurs at day 7, yellow is at day 15 and orange occurs at day 25. The prominent pigment in the green biomass is chlorophyll B, giving its green color. The orange biomass's prominent pigment is -carotene giving the orange color. The yellow biomass does not have a distinct pigment to give the yellow phenotype, it is transitioning between the two. The model properly describes this transitional stage of the yellow phenotype which presented divergent metabolic fluxes compared to the green and orange phenotypes. We can further support the model's capabilities by looking at the highest regulated reactions.

In a paper by Chen (2012), he analyzes the enzymes involved in the glycerol pathway. Based on the analysis, he concluded that the limiting enzyme in glycerol synthesis was glycerol-3-phosphate dehydrogenase (G3PDH) {Chen, H. et al., 2012} [58]. The same reaction that was found limiting in Chen's analysis, is amongst the highest regulated reactions. Both the NADP and NAD dependent versions of the glycerol-3-phosphate dehydrogenase reaction show a reversal of flux in the model. This supporting evidence further supports the accuracy of iJA983 as the three biomass equations have different glycerol concentration.

We can also see a connection between the reactions that are the most regulated between the three biomass equations. Many of the highest regulated reactions are all part of the glycolysis pathway. The reactions included are the following: alcohol dehydrogenase (glycerol, NADP), glyceraldehyde oxidoreductase (NAD), glycerol-3-phosphate dehydrogenase (NAD), glycerol-3-phosphate dehydrogenase [NAD(P)], Glucose-6-phosphate isomerase, phosphoglucomutase, glucose-6-phosphate isomerase (g6p-A), glucose-6-phosphate isomerase (g6p-B), phosphoglucomutase, chloroplast, and Enolase, chloroplast. This pathway connects the carotenoid, lipid, carbohydrate and glycerol biosynthesis. This suggests that the glycolysis pathway is essential in controlling the fluxes exhibited in the three biomass compositions connecting lipids and pigments production under changing growth conditions.

In conclusion, the GEM™ model iJA938™ is a highly comprehensive metabolic network that contains 3,225 reactions, 2,438 metabolites, and 938 genes. It has 1,295 unique reactions with 958 that are new to the BIGG™ database. The annotation of the reference Dunaliella salina genome was improved by adding 217 new metabolic functions that previously were listed “hypothetical proteins” and by identifying protein localizations. This model includes an expanded network of odd chain fatty acid synthesis that were incorporated to build the featured lipids of D. salina. The accuracy of the model was improved to 94% and was validated by the lower error rates comparing the experimental and simulated growth rates. Therefore, the model can be further utilized to study the changes in the central carbon metabolism that lead to the production of lipids and pigments under changing growth conditions.

### REFERENCES DISCUSSION

1 AOAC International 2023, 22 Ed., Official Methods
2 G. L. Douglas, J. Nutr., 2020, 150
3 T. Cahill, Nutr. Bull. 2020, 45
4 A. Bychkov, Int J Gastron Food Sci. 2021, 24
5 M. L. Dreher, Crit Rev Food Sci Nutr. 2013, 53
6 P. J. Harvey, Algal Res. 2020, 50
7 M. Solana, J Supercrit Fluids. 2014, 92
8 C. T. Li, NPJ Syst. Biol. Appl. 2019, 5, 33
9 J. D. Tibocha-Bonilla, NPJ Syst. Biol. Appl. 2020, 6
10 T. Lafarga, Algal Res. 2019, 41

### References Example 1

[1] A. Ben-Amotz et al., “Effect of natural beta-carotene supplementation in children exposed to radiation from the Chernobyl accident,” (in eng), Radiat Environ Biophys, vol. 37, no. 3, pp. 187-93, October 1998, doi: 10.1007/s004110050116.
[2] S. Delman et al., “9-cis and all-trans beta-carotene isomers of supercritical CO2-extracted Dunaliella oil are absorbed and accumulated in mouse tissues,” Applied Phycology, vol. 2, no. 1, pp. 74-79, 2021 Jan. 1 2021, doi: 10.1080/26388081.2021.1975502.
[3] J. E. W. Polle et al., “Draft Nuclear Genome Sequence of the Halophilic and Beta-Carotene-Accumulating Green Alga Dunaliella salina Strain CCAP19/18,” (in eng), Genome Announc, vol. 5, no. 43, Oct. 26, 2017, doi: 10.1128/genomeA.01105-17.
[4] C. Zuñiga et al., “Genome-Scale Metabolic Model for the Green Alga Chlorella vulgaris UTEX 395 Accurately Predicts Phenotypes under Autotrophic, Heterotrophic, and Mixotrophic Growth Conditions,” (in eng), Plant Physiol, vol. 172, no. 1, pp. 589-602, September 2016, doi: 10.1104/pp. 16.00593.
[5] R. A. Ahmed et al., “Bioenergy application of Dunaliella salina SA 134 grown at various salinity levels for lipid production,” Scientific Reports, vol. 7, no. 1, p. 8118, 2017 Aug. 14 2017, doi: 10.1038/s41598-017-07540-x.

### References Example 2

[1] A. Ben-Amotz et al (1998) Radiation and Environmental Biophysics, 37, 187-193.
[2] S. Delman et al (2021) Applied Phycology, 2, 74-79.
[3] C. Zuniga et al (2016) Plant Physiology, 172, 589-602.
[4] M. Laska (2010) Chemical Senses, 35, 279-287.

A number of embodiments of the invention have been described. Nevertheless, it can be understood that various modifications may be made without departing from the spirit and scope of the invention. Accordingly, other embodiments are within the scope of the following claims.

What is claimed is:

1. A product of manufacture, a food, a drink, a nutritional supplement, a pill, a tablet, a capsule, a gel, a geltab, a dosage form or a kit, comprising one or mixtures of two or more or a plurality of microalgae, or mixtures of two or more different types (or species) of microalgae,
and optionally the one or mixtures of two or more or plurality of microalgae, or the mixtures of two or more different types (or species) of microalgae, comprise: blue-green algae or cyanobacteria, or extracts of the microalgae, or dried extracts of the microalgae, formulated into a food, candy, nutritional supplement, or an ingestible liquid,
wherein the one or two or more or a plurality of microalgae, or one of a mixture of two or more different types (or species) of microalgae, comprise:
a microalgae from the genus: Spirulina sp., Arthrospira sp., Limnospira sp., Chlorella sp., Dunaliella sp., and/or Nannochloropsis sp., or
comprise one or a mixture of Arthrospira maxima, Arthrospira fusiformis, Arthrospira platensis, Chlorella vulgaris, Dunaliella salina, and/or Nannochloropsis salina.

2. The product of manufacture, food, drink, nutritional supplement, pill, tablet, capsule, gel, geltab, dosage form or kit of claim 1, further comprising a prebiotic or a probiotic or a mixture thereof,
and optionally the prebiotic is or are partially or substantially dehydrated or lyophilized.

3. The product of manufacture, food, drink, nutritional supplement, pill, tablet, capsule, gel, geltab, dosage form or kit of claim 2, wherein the probiotic comprises a bacteria, an algae, or a blue-green algae or cyanobacteria or a mixture thereof.

4. The product of manufacture, food, drink, nutritional supplement, pill, tablet, capsule, gel, geltab, dosage form or kit of claim 2, wherein the prebiotic comprises a water-soluble carbohydrate (wherein optionally the water-soluble carbohydrate comprises one or more of inulin, oligofructose, fructo-oligosaccharide, galacto-oligosaccharide, glucose, starch, maltose, maltodextrins, polydextrose, amylose, sucrose, fructose, lactose, isomaltulose, a polyol), glycerol, carbonate, thiamine, choline, histidine, trehalose, nitrogen, sodium nitrate, ammonium nitrate, phosphorus, phosphate salts, hydroxyapatite, potassium, potash, sulfur, homopolysaccharide, heteropolysaccharide, cellulose, chitin, a vitamin (optionally vitamin B₁₂, vitamin D, or vitamin C), a protein source (optionally whey protein, casein, casein protein, nonfat milk, hydrolyzed protein) or any combination thereof.

5. The product of manufacture, food, drink, nutritional supplement, pill, tablet, capsule, gel, geltab, dosage form or kit of claim 1, the two or more or plurality of microalgae, or the one of the mixture of two or more different types (or species) of microalgae, comprise:
a species of the genus Spirulina, and a species of the genus Chlorella;
a species of the genus Spirulina, and a species of the genus Dunaliella;
a species of the genus Dunaliella and a species of the genus Chlorella;
a species of the genus Arthrospira, a species of the genus Limnospira;
a species of the genus Spirulina, a species of the genus Limnospira;
a species of the genus Arthrospira, a species of the genus Spirulina;
a species of the genus Spirulina, Arthrospira, and Limnospira;
a species of the genus Dunaliella and a species of the genus Arthrospira;
a species of the genus Chlorella and a species of the genus Arthrospira;
a species of the genus Dunaliella and a species of the genus Limnospira; or
a species of the genus Chlorella and a species of the genus Limnospira.

6. The product of manufacture, food, drink, nutritional supplement, pill, tablet, capsule, gel, geltab, dosage form or kit of claim 1, wherein the one or mixtures of two or more or a plurality of microalgae, or mixtures of two or more different types (or species) of microalgae, are mixed with or incorporated into a drink, dietary supplement, gel, food or vegetable,
wherein optionally the one or mixtures of two or more or a plurality of microalgae, or mixtures of two or more different types (or species) of microalgae, are mixed with or incorporated into a food, drink, dietary supplement, gel or vegetable comprising avocado,
and optionally the food is formulated as a Microalgae-Enriched Guacamole (MEG).

7. The product of manufacture, food, drink, nutritional supplement, pill, tablet, capsule, gel, geltab, dosage form or kit of claim 1, wherein the one or mixtures of two or more or a plurality of microalgae, or the mixtures of two or more different types (or species) of microalgae, is or are partially or substantially dehydrated or lyophilized.

8. The product of manufacture, food, drink, nutritional supplement, pill, tablet, capsule, gel, geltab, dosage form or kit of claim 1, wherein the dosage form selected from the group consisting of: a suppository, a biocompatible scaffold, a powder, a liquid, a capsule, a chewable tablet, a swallowable tablet, a buccal tablet, a troche, a lozenge, a soft chew, a solution, a suspension, a spray, a powder, a tincture, a decoction, a infusion and any combination thereof

9. A method for supplementing the diet of an individual in need thereof comprising administering a product of manufacture, food, drink, nutritional supplement, pill, tablet, capsule, gel, geltab, dosage form or kit of claim 1, to the individual in need thereof.

10. The method of claim 9, wherein the individual in need thereof is an astronaut, an athlete, a soldier, an individual with a digestive or a growth disorder, a burn patient, a trauma victim, a post-surgical patient and/or a cancer patient or a patient with cachexia.

11. Use of one or mixtures of two or more or a plurality of microalgae, or mixtures of two or more different types (or species) of microalgae, for supplementing the diet of an individual in need thereof,
wherein the one or mixtures of two or more or plurality of microalgae, or mixtures of two or more different types (or species) of microalgae, comprises at least one microalgae from the genus: Spirulina sp., Arthrospira sp., Limnospira sp, Chlorella sp., Dunaliella sp., and/or Nannochloropsis sp., or are Chlorella vulgaris, Dunaliella salina, and/or Nannochloropsis salina.

12. A mixture of two or more or a plurality of microalgae, or a mixture of two or more different types (or species) of microalgae, for use in supplementing the diet of an individual in need thereof,
wherein the one or mixtures of two or more or plurality of microalgae, or mixtures of two or more different types (or species) of microalgae, comprises at least one microalgae from the genus: Spirulina sp., Arthrospira sp., Limnospira sp, Chlorella sp., Dunaliella sp., and/or Nannochloropsis sp., or are Chlorella vulgaris, Dunaliella salina, and/or Nannochloropsis salina.
